(19) United States
(12) Patent Application Publication
(10) Pub. No.: US 2026/0270828 A1
(43) Pub. Date: Sep. 10, 2026

(54) RADIO CELL LOAD BALANCING FOR COMMUNICATION SERVICES VIA I/O USER DEVICES PERFORMING USER TERMINAL EMULATION AS A CLOUD COMPUTING SERVICE

(71) Applicant: Telefonaktiebolaget LM Ericsson (publ), Stockholm (SE)

(72) Inventors: Hans HANNU, LULEÅ (SE); Peter ÖKVIST, LULEÅ (SE); Patrik SALMELA, ESPOO (FI); Niklas LINDSKOG, LUND (SE); Tommy ARNGREN, SÖDRA SUNDERBYN (SE)

(21) Appl. No.: 19/162,926

(22) PCT Filed: Mar. 6, 2023
(86) PCT No.: PCT/SE2023/050198

§ 371 Date: Sep. 6, 2025

(51) Int. Cl. H04W 36/22; H04W 28/02; H04W 28/08; H04W 28/24; H04W 36/00; H04W 36/38

(52) U.S. Cl. CPC H04W 36/22; H04W 28/0236; H04W 28/0967; H04W 28/24; H04W 36/0009; H04W 36/385

(57) ABSTRACT

A method by an input and/or output (I/O) user device handler includes receiving a request of a core network node to identify which I/O user devices of a subset of a served set, which are served by a serving radio cell, have communication streams that can be moved. The method selects a target set of I/O user devices based on I/O user interface capabilities of the target set of I/O user devices being capable of and available to handle media type characteristics of the communication streams of at least some of the subset of the served set of I/O user devices. The method sends a response to the core network node indicating the target set of I/O user devices. Corresponding network nodes and core network nodes are disclosed.

### TECHNICAL FIELD

The present disclosure relates to providing communication services through user terminals of a wireless communications system.

### BACKGROUND

The market for user terminals is driven by the quest to provide users with increasingly advanced communication and other operational features within the constraints of a portable handheld form factor. The development requirements for user terminal are increasingly complex as designers seek to integrate a greater variety of user interfaces and advanced operational features within the portable handheld form factor. Advancements in operational features have required more highly integrated and faster processing circuits with greater circuit densities, which becomes more difficult under constraints on costs and power consumption.

This all-inclusive feature-rich approach for user terminal development does not satisfy all of the myriad of differing desires held by consumers seeking solutions for the rapidly expanding variety of communication services. Moreover, the always-connected expectations of today's society obligate users to vigilantly keep their user terminals within reach or risk being unable to timely receive or initiate communication services.

In 3GPP, radio network nodes such as eNB or gNB (e/gNB) may communicate with each other over X2/Xn to request and share standardized load metrics. The e/gNB can perform load balancing, i.e. initiate UE(s) to be handover from one e/gNB to another e/gNB, in case the e/gNB is experiencing an overload condition. However, such load balancing operations are not adapted for use when UEs handling communication streams which are performing user terminal emulation as a cloud computing service.

### SUMMARY

Some embodiments disclosed herein are directed to a network node that includes at least one processor and at least one memory storing program code that is executable by the at least one processor to respond to an indication of overload condition of a serving radio cell by performing operations. The operations include to send a load balancing enquire message toward a core network node to initiate a request for an input and/or output (I/O) user device handler (IODH) to identify a target set of I/O user devices having I/O user interface capabilities which are capable of and available to handle media type characteristics of communication streams sent by and/or received by a subset of a served set of I/O user devices via the serving radio cell and a user terminal emulation server. The operations receive a load balancing enquire response message identifying the target set of I/O user devices, and select a group of the target set of I/O user devices to be substituted for a group of the I/O user devices in the served set. The operation initiates movement of at least some of the communications streams to the selected group of the target set of I/O user devices for sending and/or receiving the group of the communication streams via the user terminal emulation server (100) and a target radio cell and/or the serving radio cell.

Some related embodiments disclosed herein are directed to a core network node that includes at least one processor and at least one memory storing program code that is executable by the at least one processor to respond to receipt of a load balance enquire message of a serving radio cell by performing operations. The operations include to identify a served set of I/O user devices sending and/or receiving communication streams through the serving cell. The operations access a subscriber database to select a subset of the served set of I/O user devices based on the subset being handled by a same I/O user device handler (212). The operations send a request for the I/O user device handler to identify which of the subset of the served set of I/O user devices have communication streams that can be moved. The operations receive a response indicating a target set of I/O user devices selected by the I/O user device handler based on I/O user interface capabilities of the target set of I/O user devices being capable of and available to handle media type characteristics of the communication streams of at least some of the subset of the served set of I/O user devices. The operations send to a network node a load balancing enquire response message identifying the target set of I/O user devices. In some further embodiments, the network node may include an e/gNB or may include the I/O user device handler.

Some related embodiments disclosed herein are directed to an IODH that includes at least one processor and at least one memory storing program code that is executable by the at least one processor to perform operations. The operations include to receive a request of a core network node to identify which I/O user devices of a subset of a served set, which are served by a serving radio cell, have communication streams that can be moved. The operations select a target set of I/O user devices based on I/O user interface capabilities of the I/O user devices being capable of and available to handle media type characteristics of the communication streams of at least some of the subset of the served set of I/O user devices. The operations send a response to the core network node indicating the target set of I/O user devices.

Some other embodiments are directed to a corresponding method by a network node. The method responds to an indication of overload condition of a serving radio cell by sending a load balancing enquire message toward a core network node to initiate a request for an IODH to identify a target set of I/O user devices having I/O user interface capabilities which are capable of and available to handle media type characteristics of communication streams sent by and/or received by a subset of a served set of I/O user devices via the serving radio cell and a user terminal emulation server. The method receives a load balancing enquire response message identifying the target set of I/O user devices, and selects a group of the target set of I/O user devices to be substituted for a group of the I/O user devices in the served set. The method initiates movement of at least some of the communications streams to the selected group of the target set of I/O user devices for sending and/or receiving the group of the communication streams via the user terminal emulation server and a target radio cell and/or the serving radio cell.

Some other embodiments are directed to a corresponding method by a core network node. The method responds to receipt of a load balance enquire message of a serving radio cell by identifying a served set of I/O user devices sending and/or receiving communication streams through the serving cell. The method accesses a subscriber database to select a subset of the served set of I/O user devices based on the subset being handled by a same I/O user device handler (212). The method sends a request for the I/O user device handler to identify which of the subset of the served set of I/O user devices have communication streams that can be moved. The method receives a response indicating a target set of I/O user devices selected by the I/O user device handler based on I/O user interface capabilities of the target set of I/O user devices being capable of and available to handle media type characteristics of the communication streams of at least some of the subset of the served set of I/O user devices. The method sends to the network node a load balancing enquire response message identifying the target set of I/O user devices.

Some other embodiments are directed to a corresponding method by an IODH. The method includes receiving a request of a core network node to identify which I/O user devices of a subset of a served set, which are served by a serving radio cell, have communication streams that can be moved. The method selects a target set of I/O user devices based on I/O user interface capabilities of the target set of I/O user devices being capable of and available to handle media type characteristics of the communication streams of at least some of the subset of the served set of I/O user devices. The method sends a response to the core network node indicating the target set of I/O user devices.

Some potential advantages of these and related embodiments include that a user can receive and initiate communication services without the necessity of a traditional all-inclusive feature-rich user terminal. The operations emulate a user terminal using one or more networked I/O user devices that are proximately located to a user tag transported by the user, and where the I/O user devices individually or combinable have user interface (UI) capabilities to provide an I/O user interface for the user to interface with a user terminal emulation application of a user terminal emulation server to perform a communication service. Various embodiments disclosed herein can provide and improve upon management of loading of radio cells which are being used to carry communication streams for emulating a user terminal using I/O user device(s). The load management decisions can be adapted to determine which I/O user devices are capable of and available to handle media type characteristics of the communication streams through the user terminal emulation server.

Other network nodes, core network nodes, IODHs and corresponding methods thereof will be or become apparent to one with skill in the art upon review of the following drawings and detailed description. It is intended that all such additional network nodes, core network nodes, IODHs and corresponding methods be included within this description, be within the scope of the present inventive subject matter, and be protected by the accompanying claims. Moreover, it is intended that all embodiments disclosed herein can be implemented individually or combined in any way and/or combination.

### BRIEF DESCRIPTION OF THE DRAWINGS

Aspects of the present disclosure are illustrated by way of example and are not limited by the accompanying drawings. In the drawings:

FIG. 1 illustrates a system with a user terminal emulation server that operationally integrates sets of I/O user devices that are proximately located to users to logically form virtualized user terminals providing communication services in accordance with some embodiments of the present disclosure;

FIG. 2 illustrates a block diagram illustrating the user terminal emulation server communicating with various elements of a cellular system to provide communication services in accordance with some embodiments of the present disclosure;

FIG. 3 illustrates a block diagram illustrating the user terminal emulation server communicating in a different manner with various elements of a cellular system to provide communication services in accordance with some other embodiments of the present disclosure;

FIGS. 4 and 5 illustrate combined flowcharts of operations and related data flows between a user tag, I/O user devices, an Extensible Authentication Protocol (EAP) authenticator, and a user terminal emulation server which may include an EAP server in accordance with some embodiments of the present disclosure;

FIG. 6 illustrates a combined flowchart of operations and related data flows between a user tag, I/O user devices, a 3GPP key agreement function system, and a user terminal emulation server in accordance with some embodiments of the present disclosure;

FIG. 7 illustrates a block diagram of hardware circuit components of an I/O user device which are configured to operate in accordance with some embodiments;

FIG. 8 illustrates a block diagram of hardware circuit components of a user terminal emulation server and/or an I/O device handler (IODH) that are configured to operate in accordance with some embodiments of the present disclosure;

FIG. 9 illustrates a block diagram of hardware circuit components of an EAP authenticator or AKMA server that are configured to operate in accordance with some embodiments of the present disclosure;

FIG. 10 illustrates a block diagram of hardware circuit components of a core network node that are configured to operate in accordance with some embodiments of the present disclosure;

FIG. 11 illustrates a block diagram of hardware circuit components of a radio network node that are configured to operate in accordance with some embodiments of the present disclosure;

FIG. 12 illustrates a mobility scenario and some related mobility management operations that can be performed by an IODH in accordance with some embodiments of the present disclosure.

FIGS. 13A and 13B illustrate operations for mobility management of an active session in accordance with some embodiments of the present disclosure;

FIG. 14 illustrates operations for mobility management during idle in accordance with some embodiments of the present disclosure;

FIG. 15 illustrates a flowchart of operations that can be performed by a network node (e.g., radio network node) and core network to perform load balancing;

FIG. 16 illustrates another flowchart of operations that can be performed by a network node (e.g., radio network node), core network, and IODH to perform load balancing when user terminal emulation is being performing through I/O user communicating with a user terminal emulation server, in accordance with some embodiments of the present disclosure;

FIG. 17 illustrates combined flowcharts and data flows of a network node (e.g., radio network node) providing a serving cell, a core network (CN) node, an IODH, and a user terminal emulation (UTE) server to perform load balancing when user terminal emulation is being performing through I/O user devices (IODs) communicating with the user terminal emulation server, in accordance with some embodiments of the present disclosure;

FIG. 18 illustrates a flowchart of operations that can be performed by a network node for load balancing when user terminal emulation is being performing through I/O user devices communicating with a user terminal emulation server, in accordance with some embodiments of the present disclosure;

FIG. 19 illustrates a flowchart of operations that can be performed by a core network node for load balancing when user terminal emulation is being performing through I/O user devices communicating with a user terminal emulation server, in accordance with some embodiments of the present disclosure; and

FIG. 20 illustrates a flowchart of operations that can be performed by an IODH for load balancing when user terminal emulation is being performing through I/O user devices communicating with a user terminal emulation server, in accordance with some embodiments of the present disclosure.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of various present inventive concepts to those skilled in the art. It should also be noted that these embodiments are not mutually exclusive. Components from one embodiment may be tacitly assumed to be present or used in another embodiment.

As explained above, radio network nodes (e.g., eNB or gNB, “e/gNB”) can communicate with each other over X2/Xn to request and share standardized load metrics. A network node can use load metrics to perform load balancing of a radio cell experiencing an overload condition, i.e., such as by initiating handover of UE(s) from a first radio cell to a second radio cell, wherein the first and second radio cells may be served by the same radio network node or different radio network nodes. The network node may be radio network node or another, e.g., higher-level node, that helps control a radio network node. Various embodiments disclosed herein are directed to operations for performing load balancing when UEs and other input and/or output (I/O) user devices are performing user terminal emulation as a cloud computing service via a user terminal emulation server.

The operations may be adapted to handle various scenarios that may uniquely arise with I/O user devices performing user terminal emulation as a cloud computing service via a user terminal emulation server. In one scenario, an I/O user device is not available for handover to the second radio cell to perform user terminal emulation because it is stationary and/or is only allowed to access one or a few given cell(s) which are not the second radio cell. In another scenario, an I/O user device belongs to a certain network slice that is only supported at a certain frequency band or location, e.g. hotspot area, and not all radio cells and/or radio network nodes support the certain network slice. In another scenario, an I/O user device uses both WiFi and/or 3GPP technology, and should be handed off to either a WiFi radio cell or a 3GPP radio cell depending upon which has an overload condition. Hence, these and other operations disclosed herein are adapted to more predictably and reliably handle overload conditions which can occur in these and other scenarios where user terminal emulation through I/O user devices is being performed as a cloud computing service via a user terminal emulation server.

Some potential advantages of these and related embodiments include that a user can receive and initiate communication services without the necessity of a traditional all-inclusive feature-rich user terminal. The operations emulate a user terminal using one or more networked I/O user devices that are proximately located to a user tag transported by the user, and where the I/O user devices individually or combinable have user interface (UI) capabilities to provide an I/O user interface for the user to interface with a user terminal emulation application of a user terminal emulation server to perform a communication service. Various embodiments disclosed herein can provide and improve upon management of loading of radio cells which are being used to carry communication streams for emulating a user terminal using I/O user device(s). The load management decisions can adapt to determination of which I/O user devices are capable of and available to handle media type characteristics of the communication streams through the user terminal emulation server.

Dynamic allocation of I/O user device capabilities whenever and wherever the I/O user devices are in the proximity of a user enables efficient and flexible use of existing hardware, such as televisions, conference phones, laptops, surveillance cameras, connected household appliances, connected cars, etc., that is capable of providing necessary UI functionality to user during a communication service. The user thereby has reduced or no need to carry an expensive and all-inclusive user terminal, e.g., smart phone, that includes all necessary UI capabilities, display device, keyboard, speakers, etc. The user may instead carry a hardware device which operates to identify the user, referred to as a “UserTag” or “user tag”, over a wireless or wired (e.g., smartcard reader) communication interface, such as a near field communication (NFC) interface, to one or more of the I/O user devices. Various embodiments disclosed herein may disrupt the traditional handset-centric mobile communication industry as the features and capabilities of what forms a user terminal are not constrained to the domain of mobile phone manufacturers. A user terminal emulation server can operate to provide a user terminal, which can also be referred to as a SoftUE or a user terminal emulation application that is run by the user terminal emulation server.

The mobility management decisions for switching streams between I/O user devices for load balancing of radio network cells can be made to track in more real-time proximity and radio conditions indicated by the beacon signal measurements reported by the I/O user devices, and be performed while maintaining secure control plane termination in the user tag and secure data plane termination in the I/O user devices

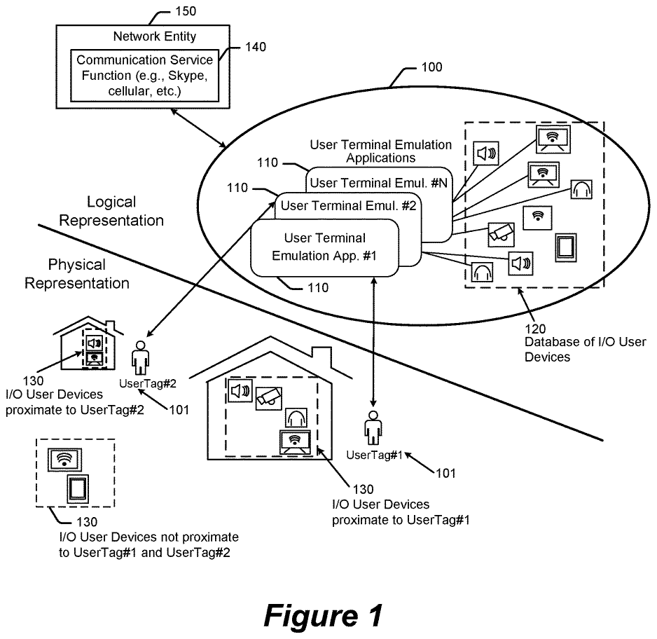

FIG. 1 illustrates a system with a user terminal emulation server 100 that can use one or more I/O user devices 130 that is/are proximately located to users to logically emulate a user terminal providing a communication service in accordance with some embodiments of the present disclosure. The user terminal emulation server 100 may operationally integrate the UI capabilities of a set of the I/O user devices 130 to logically emulate a user terminal providing communication services in accordance with some embodiments of the present disclosure.

Referring to FIG. 1, the user terminal emulation server 100 may be a cloud resource that is networked and remote from the I/O user devices 130, or may be more proximately located on a shared network with the I/O user devices 130. The user terminal emulation server 100 is configured to communicate with the I/O user device(s) 130 proximately located to a user who can use the UI capabilities of the proximate I/O user device(s) 130 during a communication service.

Users may carry a hardware tag, a.k.a. “UserTag”, “user tag” or “UT”, which is capable of transmitting a unique user identifier through a communications interface, such as a near-field communications interface (e.g., Bluetooth, BLE, NFC, RFID, etc., or combinations thereof), for receipt by one or more of the I/O user devices 130 which are proximately located to the user. One type of user tag can be a low-complexity stand-alone electronic device having limited operational capability for transmitting an identifier through a near-field communications interface and performing authentication operations such as described herein. Another type of user tag can have more operational capability (e.g., processing and memory hardware resources), such as a smartphone or smartwatch having cellular connectivity that transmits a cellular identity (e.g., from a SIM card) or an application identity through a cellular interface or a near-field communications interface and is configured to perform authentication operations such as described herein. A user tag may be a device that does not require human interaction in order to interact with an I/O user device, and may lack a user interface. A user tag may be configured to interact with one or more types of Internet of things (IoT) devices, such as a camera, sensor, or other electronic device having Internet or other wireless connectivity.

The user identifier may alternatively or additionally be operationally determined by biometrics operations performed by, e.g., one or more of the I/O user devices 130. The biometrics operations may include, without limitation, one or more of voice recognition, image/face recognition, eye recognition, fingerprint recognition, or a combination thereof. The user identity may be determined based on credential provided by the user when, e.g., logging into an application or account. The user identity may be provided by a cell phone using information from the subscription SIM and proximity of the cell phone to one or more of the I/O user devices 130 can be determined using the phone's NFC capability.

A user identifier, a user tag identifier, and a user terminal emulation application 110 can be logically associated with each other in a database 120 during a user registration process or as part of another setup process. For example, during a user registration process a user may obtain an account login identifier (serving as the user identifier) that is registered in the database 120 as being associated with a user tag identifier for a physical user tag that has been provided to (e.g., purchased by) the user and being associated with a user terminal application 110 that emulates a user terminal having defined capabilities (e.g., a cell phone providing cellular and over-the-type voice-over-IP communication services).

The user terminal emulation server 100 may maintain in the database 120 network addresses of I/O user devices 130 and UI capabilities of the I/O user devices 130. Although the database 120 is illustrated as residing in the example server 100, in some other embodiments information described below as residing in the database 120 may alternatively or additionally be stored within the IODH 212 and/or the user terminal emulation applications 110. The capabilities of the I/O user devices 130 may be logically arranged in the database 120 based on the type of UI capability provided, e.g., display device, microphone, speaker, physical/virtual keyboard, and may be further arranged based on a quality of service provided by the UI capability.

The user terminal emulation server 100 may register a network address of one of the user terminal emulation applications 110 and an identity of a user with a network entity 150 providing communication services. The network entity 150 provides a communication service function 140 which may, for example, correspond to an over-the-top Voice Over Internet Protocol (VOIP) service, streaming media service (e.g., Netflix), social media service (e.g., Facebook), electronic mail service (e.g., Microsoft Outlook), online meeting service (e.g., Microsoft Teams), messaging service (e.g., Google Messenger), Internet browser service, a cellular communication service, etc. The user terminal emulation application 110 is executed by the user terminal emulation server 100. A user terminal emulation application 110 may run one or more applications that are normally run by a smart phone, such as a Netflix application, Facebook application, Microsoft Teams application, Internet browser application, etc.

As illustrated in FIG. 1, a different instantiation of the user terminal emulation application 110 may be hosted by the server 100 for each user who is to be provided communication services (i.e., illustrated user terminal emulation applications #1-#N corresponding to users 1-N). The user terminal emulation application 110 may perform registration of the user with the network entity 150 and setup of a communication service with a user responsive to communication requests.

When the communication service function 140 of the network entity 150 is a VoIP service, the operation to register the network address of the user terminal emulation application and the identity of the user with the network entity can include registering the network address of the user terminal emulation application 110 and the identity of the user with a network server of a VoIP communication service provider.

When the communication service function 140 of the network entity 150 is a cellular communication service, the operation to register the network address of the user terminal emulation application and the identity of the user with the network entity can include registering the network address of the user terminal emulation application 110 and the identity of the user with a Home Subscriber Server (HSS) 211, Unified Data Management (UDM), or other network node of a core network operated by a cellular communication service provider.

The user terminal emulation server 100 may receive the registration messages from the I/O user devices using the Session Initiation Protocol (SIP)/Session Description Protocol (SDP), where each of the registration messages identifies the network address and the UI capability of one of the I/O user devices. The communication request may be received from the network entity 150 using the SIP/SDP, and the operation to provide communication sessions between the user terminal emulation application 110 and each of the I/O user devices in the set, and between the user terminal emulation application 110 and the requesting user terminal may be performing using the SIP/SDP.

A registration message from an I/O user device can include, for example, an IP address and port number, MAC address, fully qualified domain name (FQDN), and/or another network address, and can further include information identifying the UI capability of the I/O user device. The I/O user device may respond to becoming powered-on by communicating the registration message to the user terminal emulation server 100.

The user terminal emulation server 100 receives a communication request from the network entity 150 for establishing a communication service between the user and a requesting user terminal, e.g., a cellular phone, computer with Microsoft Teams application, etc. Responsive to the communication request, the user terminal emulation server 100 identifies one or more of the I/O user devices 130, which may be registered in the database, that are proximately located to a location of the user and are determined, based on the UI capabilities identified by the database 120 for the set of I/O user devices and based on content of the communication request, to satisfy a capability rule for being individually usable or combinable to provide an I/O user interface for the user to interface with the user terminal emulation application 110 to provide the communication service. Although various operations are described above and elsewhere as being performed by the user terminal emulation server 100, it is to be understood that these and other operations are performed by the user terminal emulation server 100 executing one or more of the user terminal emulation applications 110 instantiated for a user.

The user terminal emulation server 100 provides one or more communication sessions between the user terminal emulation application 110 and the one or more I/O user devices 130 and between the user terminal emulation application 110 and the requesting user terminal via the network entity 150. The communication request that is received by the user terminal emulation application 110 may contain an indication of a minimum UI capability that must be provided to the user during the communication service, such as: speaker only; combination of speaker and microphone; display only; combination of display device, speaker, and microphone; etc. A UI capability rule which can be used by the server 100 to determine whether a communication service can be provided and by which set of I/O user devices, may thereby be defined based on the minimum UI capability that is indicated by the communication request.

The user terminal emulation server 100 then routes communication traffic between at least one of the I/O user devices in the set and the requesting user terminal via the network entity 150. In some embodiments, for example, for each data type that is received as communication traffic from the requesting user terminal, the user terminal emulation server 100 selects one of the I/O user devices from among the set of I/O user devices based on matching characteristics of the data type to the UI capabilities identified by the database 120 for the one of the I/O user devices, and then routes the data of the data type toward the network address of the selected one of the I/O user devices.

As will be explained in further detail below, the server 100 may also combine data streams that are received from the I/O user devices in the set, and route the combined data streams towards the requesting user terminal, e.g., via the network entity 150.

The user terminal emulation server 100 (e.g., the application 110 or an I/O user device handler described below) may be responsible for tracking which I/O user devices are proximately located to a present location of the user. The server 100 can receive presence reports from individual ones of the I/O user devices containing their network address and an identifier of a user tag which is determined by the I/O user device to be proximately located thereto. For example, an I/O user device may read a user tag through a NFC communication interface and/or may perform other operations to detect presence of a user and to identify a user tag transported by the user. Responsive to the presence reports, the server 100 updates the database 120 to indicate which user tag identifiers are proximately located to which of the I/O user devices.

With further reference to the example system of FIG. 1, a set of I/O user devices 130 has been determined by the IODH 212 to be proximately located to a location of a first user carrying UserTag #1, and to further have UI capabilities that are combinable to satisfy the UI capability rule for providing a combined I/O user interface for the first user to use during a requested communication service. IODH 212 responsively uses that set of I/O user devices 130 to provide a combined I/O user interface for use by the first user during a communication service via Application #1 and network entity 150 between the first user and another user terminal.

Similarly, another set of I/O user devices 130 has been determined by the IODH 212 to be proximately located to a location of a second user carrying UserTag #2, and to further have UI capabilities that are combinable to satisfy the UI capability rule for providing a combined I/O user interface for the second user to use during a requested communication service. IODH 212 responsively uses that set of I/O user devices 130 to provide a combined I/O user interface for use by the second user during a communication service via Application #2 and network entity 150 between the second user and yet another user terminal.

FIG. 1 also illustrates that another set of I/O user devices 130 is not proximately located to either UserTag #1 or UserTag #2.

As explained above, the communication request which is requesting the establishment of communication service with an identified user may be initiated by the network entity 150 using the network address of the user terminal emulation application and identity of the user which were earlier registered with the network entity 150. However, the communication request may additionally or alternatively be generated by one of the I/O user devices 130 responsive to a command received from a proximately located user. For example, a user tag may operate automatically or through action of the user to initiate communications with one of the I/O user devices 130. Alternatively, a user may operate a user interface provided by one of the I/O user devices 130 to initiate, e.g., a combined audio and video call with another user. An identity of the user tag may be sent with the communication request, or the identity of the user tag may be bound to the communication session between the I/O user device and the user terminal emulation server 100. The application 110 performs the identifying, providing, routing, selecting, and combining operations described above to set up and operate a communication service between the user and the other user via the network entity 150.

Further example systems and related operations will now be described to further illustrate how I/O user devices having different UI capabilities can be operationally used or combined to provide a combined UI that can be used by user to satisfy the communication requirements of a communication service.

Further illustrative operations are described regarding an example embodiment in which a speaker device is one of the I/O user devices 130 in the set capable of playing a received audio stream and a microphone device is one of the I/O user devices 130 in the set capable of sensing audio to provide a microphone stream. Operations by the user terminal emulation application include updating the database 120 based on content of registration messages from the speaker device and the microphone device to identify network addresses of the speaker device and the microphone device, and to identify UI capabilities of the speaker device as having a speaker capability and the microphone device as having a microphone capability. The speaker UI capabilities may identify a number of speakers provided, sound loudness capability, and/or other operational characteristics. The microphone UI capabilities may identify a number of microphones provided, sensitivity of the microphones, and/or other operational characteristics. The speaker device and the microphone device are each identified as belonging to the set of I/O user devices that are determined to be proximately located to the location of the user (e.g., UserTag #1) and are further determined, based on the UI capabilities identified by the database 120, to satisfy the UI capability rule for used individually or combined to provide a combined I/O UI for the user to interface with the user terminal emulation application 110 to provide the communication service. Based on determining that the speaker device and the microphone device satisfy the UI capability rule, further operations are performed to route a microphone stream received from the microphone device toward the requesting user terminal (e.g., via network entity 150). When an audio stream is received as communication traffic from the requesting user terminal the operations select the speaker device based on matching an audio characteristic of the audio stream to the speaker capability identified by the database 120 for the speaker device, and then route the audio stream toward the network address of the speaker device.

The example embodiment may include, when a display device is one of the I/O user devices in the set capable of displaying a received video stream, the operations update the database 120 based on content of registration messages to identify network addresses of the display device, and to identify UI capabilities of the display device as having a display capability. The display UI capabilities may identify a screen display size, aspect ratio, pixel resolution, video frame rates supported, whether display device supports shared user support via split screen configuration, and/or other operational characteristics. The display device is also identified as among the set of I/O user devices that determined, based on the UI capabilities identified by the database 120, to satisfy the UI capability rule for being used individually or combined to provide the combined I/O UI for the user to interface with the user terminal emulation application 110 to provide the communication service. In an optional further embodiment, the set of I/O user devices is further selected based on each of the I/O user devices satisfying a rule for being proximately located to the location of the user. Based on determining that the speaker device, the display device, and the microphone device satisfy the UI capability rule, further operations respond to receipt of video stream as communication traffic from the requesting user terminal by selecting the display device based on matching a video characteristic of the video stream to the display capability identified by the database 120 for the display device, and then routing the video stream toward the network address of the display device.

In the example embodiment the operations for routing the audio stream and the video stream toward the network addresses of the speaker device and the display device, respectively, may include when audio data and video data are received within a same stream from the requesting user terminal through a first communication session: separating the audio data from the video data; routing the audio data toward the network address of the speaker device through a second communication session; and routing the video data toward the network address of the display device through the second communication session or a third communication session.

The example embodiment may include, when a camera device is one of the I/O user devices in the set capable of providing a camera stream, the operations update the database 120 based on content of a registration message to identify a network address of the camera device and to identify a UI capability of the camera device as having a camera capability. The camera UI capabilities may identify a camera pixel count, image quality, light sensitivity, and/or other operational characteristics. The camera device is further identified as a member of the set of I/O user devices that are determined to be proximately located to the location of the user and is further determined, based on the UI capability identified by the database 120, to satisfy the UI capability rule for being used individually or combined with the other I/O user devices in the set to provide the combined I/O UI for the user to interface with the user terminal emulation application 110 to provide the communication service. Based on determining that the camera device satisfies the UI capability rule, further operations are performed to route the camera stream received from the camera device toward the requesting user terminal, e.g., via the network entity 150.

The operations for routing the microphone stream received from the microphone device and the camera stream received from the camera device toward the requesting user terminal, can include: receiving the microphone stream from the microphone device through a first communication session; receiving the camera stream from the camera device through the first communication session or a second communication session; combining the microphone stream and camera stream in a combined stream; and routing the combined stream toward the requesting user terminal through a third communication session, e.g., via the network entity 150.

The example embodiment may include, when a keyboard device is one of the I/O user devices in the set capable of outputting key selection data responsive to key selections by a user among keys of the keyboard device, the operations can update the database 120 based on content of a registration message to identify a network address of the keyboard device and to identify a UI capability of the keyboard device as having a keyboard capability. The keyboard device capabilities may identify a key count, indication of whether the keyboard is a physical keyboard or a touch sensitive input device, and/or other keyboard capabilities. The keyboard device is further identified as a member of the set of I/O user devices that are determined to be proximately located to the location of the user and is further determined, based on the UI capability identified by the database 120, to satisfy the UI capability rule for being used individually or combined with the other I/O user devices in the set to provide the combined I/O UI for the user to interface with the user terminal emulation application 110 to provide the communication service. Based on determining that the keyboard device satisfies the UI capability rule, further operations are performed to identify commands formed by the key selection data received from the keyboard and to perform operations that have been predefined as being triggered based on receipt of the identified commands.

The operations for routing the key selection data received from the keyboard device and microphone stream received from the microphone device, may include: receiving the key selection data from the keyboard device through a first communication session receiving the microphone stream from the microphone device through the first communication session or a second communication session; combining the key selection data and the microphone stream in a combined stream; and routing the combined stream toward the requesting user terminal through a third communication session, e.g., via the network entity 150.

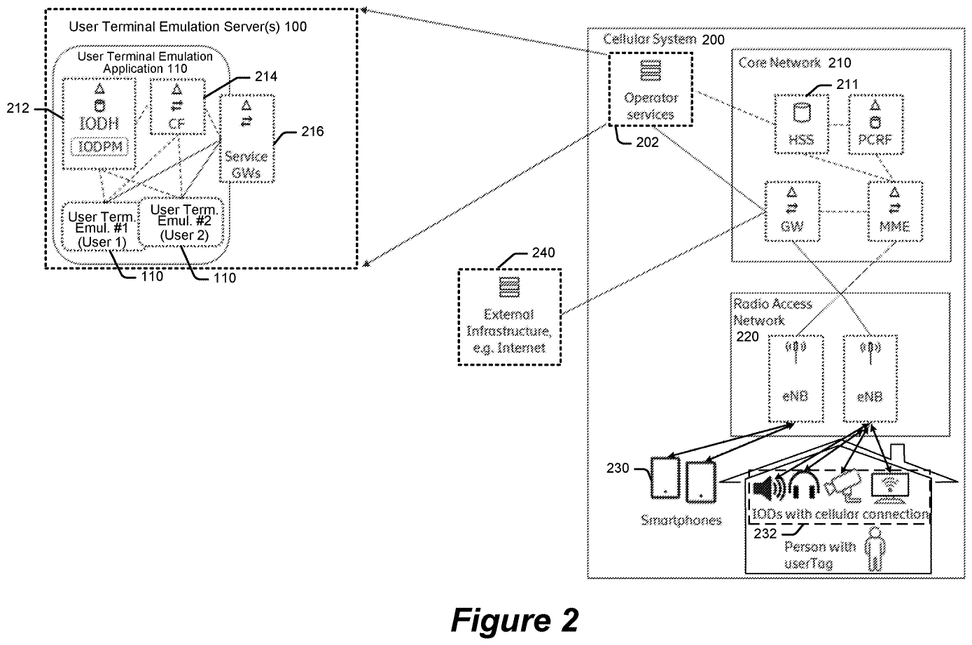

FIG. 2 is a block diagram illustrating the user terminal emulation server 100 as an element of an operator service node 202 within a cellular system 200. Referring to FIG. 2, the communication service function of the network entity 140 (FIG. 1) may be provided by the operator service node 202 or may be reached through external infrastructure 240, e.g., the Internet or private network. The server 100 may, for example, be implemented in the radio access network 220 to provide edge computing with faster responsiveness or may be implemented within another node of the cellular system 200. The user terminal emulation server 100 can include an I/O user device handler (IODH) 212, a control function (CF) 214, the instantiated user terminal emulation applications 110, and a service gateway (GW) 216. A user terminal emulation application 110 may perform one or more user applications which are provided by a smart phone, such as a Netflix application, Facebook application, Microsoft Teams application, Internet browser application, etc.

The user terminal emulation server 100, or the IODH 212 which can be part of the server 100, may perform operations to manage the I/O user devices, such as to handle maintenance of the database 120, perform registration of I/O user devices to be available for use by the user terminal emulation applications 110, and manage mobility through operations for setting up and performing handover of communication services through I/O user devices. For example, the user terminal emulation server 100 may operate to identify the IP address of a user terminal emulation application, e.g., which encapsulates a Microsoft Teams application, for a subscriber with a service provider, e.g., a Microsoft Teams server. In some other embodiments, the IODH 212 may be located outside the user terminal emulation server 100 in another network node of the system. The CF 214 may be responsible for assigning an IP address to each user terminal emulation application 110. The IP address to be assigned by the CF 214 may be received from the core network 210 functionality such as a PDN-GW. The service GW 216 may interconnect the user terminal emulation server 100 to a PSTN network, packet data network gateway of a 3GPP (3rd Generation Partnership Project) system, etc. The cellular system 200 can include a Core Network 210 having a Home Subscriber Server (HSS) 211, a Policy and Charging Roles Function (PCRF), gateway (GW) and Mobility Management Entity (MME) providing control signaling related to mobile terminal mobility and security for the radio access. The HSS 211 contains subscriber-related information and provides support functionality for user authentication and user access to the system. The PCRF enables QoS control per data flow and radio bearer, by setting QoS rules for each data flow, based on operator set policies and subscriber information. The GW can include a Serving GW (S-GW) and a Packet Data Network GW (PDN-GW), where the S-GW interconnects the core network 210 with the radio access network 220 and routes incoming and outgoing packets for the I/O user devices 232 and/or 130 and the user terminals 230. The PDN-GW interconnects the core network 210 with external infrastructure 240, such as the Internet, and allocates IP-addresses and performs policy control and charging.

Some I/O user devices 232 having cellular communication capability can communicate via, e.g., eNBs or other radio access nodes of a Radio Access Network 220 with the operator service node 202 via the core network 210. In the system of FIG. 2, the user terminal emulation server 100 may handle set up of a communication service between a selected set of the I/O user devices that are proximate to a user and a remote user terminal 230 (e.g., smart phone) via the cellular system 200.

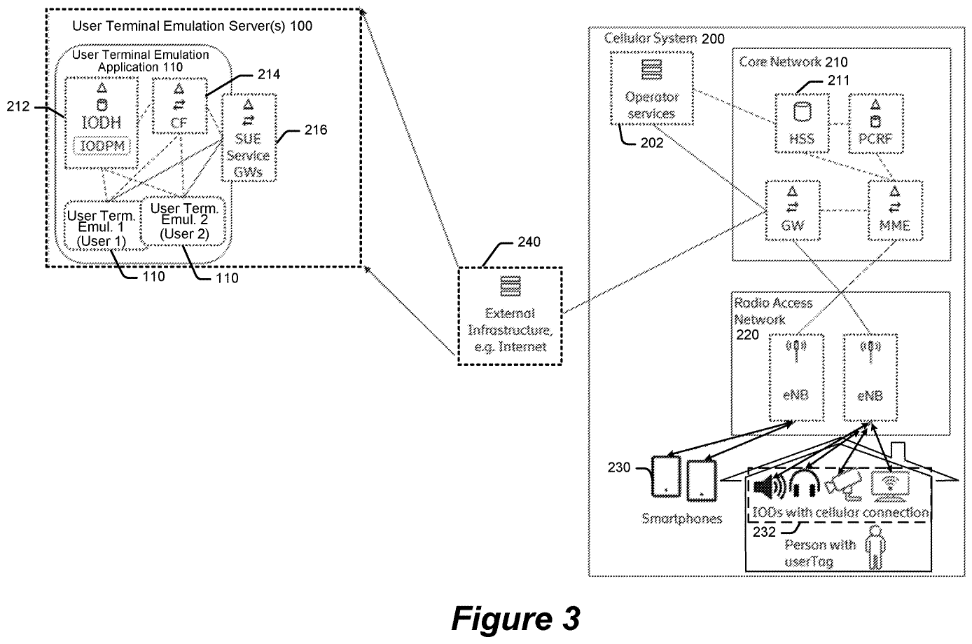

FIG. 3 is a block diagram illustrating the user terminal emulation server 100 communicating in a different manner with various elements of a cellular system 200, which may operate as the network entity 140 (FIG. 1), to provide communication services in accordance with some embodiments of the present disclosure. The system of FIG. 3 differs from the system of FIG. 2 by the user terminal emulation server 100 being an Internet service within external infrastructure 240 outside of the cellular system 200. In the system of FIG. 3, the CF 214 may determine the IP address to be assigned to different ones of the user terminal emulation applications 110 based on signaling from the Internet service within the external infrastructure 240.

The above and other example operations will now be described in further detail in the context of two different example “use cases”: 1) incoming call scenario; and 2) outgoing call scenario.

### Use Case 1: Incoming Call Scenario Operations are Now Discussed Below.

This use case involves a user, with a user tag or other way of being identified, being proximately located to I/O user devices 130 having different UI capabilities when an incoming call is received by the user terminal emulation server. Although operations are explained below in the context of identifying a user through a physical user tag transported by the user, these operations are not limited thereto and may be used with any other way of identifying a user, such as by sensing biometric information that identifies the user and involving operational communications with the user tag transported by the user.

A user terminal emulation application 110 may be instantiated or otherwise activated responsive by an incoming call (service, session) targeting the user tag. The user terminal emulation application 110 can identify subscriptions associated with the user tag (e.g., registered in a user account) and preferred methods of communication (e.g., audio not video, audio and video, etc.) that have been specified by the user, and determines the UI capabilities of the I/O user devices that will be needed to satisfy the UI capabilities which may be specified for the incoming communication session. The user terminal emulation application 110 may ask the IODH to identify which I/O user devices 130 are proximately located to the user tag, and may further ask the IODH to determine or may determine itself whether the identified I/O user devices 130 are usable individually or combinable to satisfy the UI capabilities specified by the incoming communication session. The user terminal emulation application 110 and/or the IODH may receive an ACK or NACK back on whether a sufficient set of I/O user devices 130 can be used to provide the communication service. If ACK, then the IODH also sets the state of the I/O user devices 130 in the set to in-use to avoid another user terminal emulation application 110 attempting to utilize the same I/O user devices 130 as which are presently in use.

In case of NACK, the user terminal emulation application 110 and/or the IODH can take different actions to setup a reduced UI capability communication service with the user depending on user settings, e.g., only allow sound-based communications instead of a combination of sound and video responsive to when no display device is presently available for use. An example of no display device being available may occur when the only display device that is proximately located to the user is presently being used by another user to receive information from another user terminal emulation application during an ongoing communication service or when no display device is proximately located to the user.

Further operations by user tags, I/O user devices, and the user terminal emulation server are described in accordance with this example use case. A user tag enters a room and signals its presence to any proximately located and capable I/O user device in the room using a discovery beacon signal. Alternatively, one or more of the I/O user devices determines presence of the user tag by polling, such as by periodically transmitting discover beacon signals that trigger responsive signaling by the user tag. The I/O user devices that receive signaling indicated presence of the user tag report to the IODH 212 along with a network address of the I/O user device (e.g., IP address, port number, MAC address, FQDN, etc.).

Alternatively, the signaling may be implicit when the IODH 212 already has presence information and/or presence is determined based on content of IP packets sent from the I/O user device to the IODH 212. The IODH 212 may be executed by the user terminal emulation server as part of the user terminal emulation application, by the I/O user devices, and/or by another computing node of the system. The user terminal emulation application corresponding to the specific user (i.e., the user tag) is updated with respect to the detected user's presence. The IODH 212 may operate to receive the notifications from the I/O user devices proximately located to the user tag. Further UI capability discovery (synchronization) communications may optionally be performed between the IODH 212 and the I/O user devices, or the IODH 212 may be per-configured with knowledge of the UI capabilities of the I/O user devices. The I/O user devices are associated to the user in the database 120, along with associated indications of combinable UI capabilities provided by the set of I/O user devices which are proximately located to the user tag. One or more of the I/O user devices may be selected for default call reception ACK/NACK. The user via the user tag is now known to be reachable within the system through an identified set of I/O user devices with identified UI capabilities (e.g., speakers yes/no, display yes/no, microphone yes/no, keyboard yes/no, etc.), thereby creating a logical virtualized user terminal through which the user may be provided in a communication service. The user may receive or accept a communication service through a touchscreen, voice command sensed by a microphone, performing a defined gesture observable by a camera, and/or other input provided to one of the proximately located I/O user devices.

An incoming session (e.g., video call) from a requesting user terminal which is directed to the user (user tag) arrives at the user terminal emulation server for the user carrying the user tag. The individual or combinable UI capabilities of the available I/O user devices is compared to the UI requirements of the incoming session. When the UI requirements of the incoming session are not satisfied by the UI capabilities of the I/O user devices, the user terminal emulation server may renegotiate the required UI capabilities (e.g., QoS) of the incoming session. In contrast, when the UI requirements of the incoming session are satisfied the user terminal emulation server prompts, via one or more of the available I/O user devices (e.g., a pre-selected answer device), the user carrying the user tag to provide a session request answer (ACK/NACK). The user responds through the pre-selected answer device to accept (ACK) or reject (NACK) the incoming session, to provide signaling to the user terminal emulation server. When an ACK is received, operations route an audio stream from the requesting user terminal to one of the I/O user devices in the set that has a speaker capability via one or more sessions, and routes a video stream from the requesting user terminal to another one of the I/O user devices in the set that has a display capability via one or more sessions. A data stream that is received from one of the I/O user devices in the set through a one or more sessions is routed toward the requesting user terminal. When two or more data streams are received through one or more sessions from the I/O user devices, they can be combined into a combined data stream that is routed toward the requesting user terminal.

The user terminal emulation server or IODH may perform operations to continuously monitor presence of the I/O user devices to determine when one or more of I/O user devices is no longer proximately located to the user such that it can no longer be included as part of the combined UI be provided during the ongoing communication session. The user terminal emulation server or IODH may substitute the UI capability of another I/O user device to the set being used by the user for the ongoing communication session responsive to a previous member of the set no longer having required presence.

### Use Case 2, Outgoing Call Operations are Now Discussed Below.

This use case involves a user, with a user tag, being proximately located to I/O user devices 130 having different UI capabilities when an outgoing call (communication session) is received by the user terminal emulation server. The I/O user devices 130 are associated to the identified user via the user terminal emulation server 100 which handles all communications sessions for the user while the associated I/O user devices 130 are managed by an IODH 212.

A user terminal emulation application 110 may be instantiated or otherwise activated responsive by an outgoing call being requested by a user carrying the user tag. The user may initiate an outgoing call through a touchscreen, voice command sensed by a microphone, performing a defined gesture observable by a camera, and/or other input provided to one of the proximately located I/O user devices.

The user terminal emulation application 110 can identify subscriptions associated with the user tag and preferred methods of communication (e.g., audio not video, audio and video, etc.) that have been specified by the user, and determines the UI capabilities of the I/O user devices that will be needed to satisfy the UI capabilities which may be specified for the outgoing call. The user terminal emulation application 110 may ask the IODH 212 to identify which I/O user devices 130 are proximately located to the user tag, and may further ask the IODH 212 to determine or may determine itself whether the identified I/O user devices 130 are individually useable or combinable to satisfy the UI capabilities specified by the outgoing call. The user terminal emulation application 110 and/or the IODH 212 may receive an ACK or NACK back on whether one or a set of I/O user devices 130 can be used to provide the communication service. If ACK, then the IODH 212 also sets the state of the one or more I/O user devices 130 in the set to in-use to avoid another user terminal emulation application 110 attempting to utilize the same I/O user device(s) 130 as which are presently in use. In case of NACK, the user terminal emulation application 110 and/or the IODH 212 can take different actions to setup a reduced UI capability communication service with the user depending on user settings, e.g. only allow sound instead of the preferred sound and video responsive to when no display device is presently available for use (e.g., when presently used by another user terminal emulation application 110 or when none is proximately located to the user tag).

Example operations for an outgoing call and related data flows between user tags, I/O user devices, and the user terminal emulation server are now described in the context of this use case. A user tag enters a room and signals its presence to any proximately located and capable I/O user device in the room using a discovery beacon signal. Alternatively, one or more of the I/O user devices determines presence of the user tag by polling, such as by periodically transmitting discover beacon signals that trigger responsive signaling by the user tag. The I/O user devices that receive signaling indicated presence of the user tag report to the IODH 212 along with a network address or other identifier of the I/O user device (e.g., IP address, port number, MAC address, FQDN, etc.). The IODH 212 may be executed by the user terminal emulation server as part of the user terminal emulation application, by the I/O user devices, and/or by another computing node of the system. The user terminal emulation application corresponding to the specific user (i.e., the user tag) is updated with respect to the detected user's presence.

The IODH 212 may operate to receive the notifications from the I/O user devices proximately located to the user tag. Further UI capability discovery (synchronization) communications are performed between the user terminal emulation server or the IODH and the I/O user devices. The I/O user devices are associated to the user in the database 120, along with associated indicated service subscriptions and combinable UI capabilities provided by the set of I/O user devices which are proximately located to the user tag. One or more of the I/O user devices may be selected for use in making a call or initiating another service. The user via the user tag is now known to be reachable within the system through an identified set of I/O user devices with identified UI capabilities (e.g., speakers yes/no, display yes/no, microphone yes/no, keyboard yes/no, etc.), thereby creating a logical virtualized user terminal through which the user may be provided in a communication service. The user may initiate a communication service through a touchscreen, voice command sensed by a microphone, performing a defined gesture observable by a camera, and/or other input provided to one of the proximately located I/O user devices.

A user carrying the user tag uses the UI of one of the I/O user devices to trigger an outgoing call (e.g., video call), which triggers signaling of the outgoing call to the user terminal emulation server. The IODH 212 and/or the user terminal emulation application queries the user (e.g., displays a message, generates a sound, etc.) through one of the I/O user devices proximately located to the user to request the user to select among available types of communication methods that can be presently used for the outgoing call. One of the I/O user devices provides responsive signaling to the IODH 212 or user terminal emulation server 100 indicating the user's selected type of communication method for the outgoing call. The user terminal emulation server communicates an outgoing session stream request to the network entity 150, where the request may include an identifier of the calling user, identifier of the user terminal of the called user, and a quality of service for the communication session. The user terminal emulation server receives a communication session acceptance (ACK) or denial (NACK) from the network entity 150. When the communication session is denied, the user terminal emulation server may attempt to renegotiate the requested communication session such as at a lower quality of service.

When the communication session is accepted (ACK), for each data type that is received as communication traffic from the requested user terminal, the user terminal emulation server selects one of the I/O user devices from among the set of I/O user devices based on matching characteristics of the data type to the UI capabilities identified by the database 120 for the one of the I/O user devices, and then routes the data of the data type toward the network address of the selected one of the I/O user devices. The I/O user devices transmit data streams through one or more sessions to the user terminal emulation server, which may combine the data streams into a combined data stream that is routed toward the called user terminals via the network entity 150.

The user terminal emulation server or IODH may continuously monitor presence of the I/O user devices to determine when one or more of I/O user devices is no longer proximately located to the user such that it can no longer be included as part of the combined UI be provided during the ongoing communication session. The user terminal emulation server or IODH may substitute the UI capability of another I/O user device to the set being used by the user for the ongoing communication session responsive to a previous member of the set no longer having required presence.

### Security Issues and Related Operations are Now Discussed Below.

It can be desirable in some systems to provide operation for a virtual instance, e.g., virtual terminal emulation application 110, in the cloud, e.g., user terminal emulation server 100, to dynamically secure use of physical resources using authentication and key establishment procedures.

Some embodiments are directed to using a trusted party (function) to enable secure access and communications between a cloud service, e.g., user terminal emulation server 100 (also “Cloudphone”) and I/O user device(s) 130. These embodiments may extend existing authentication functions to establish a secure association among various elements of the systems described in FIGS. 1-3 and, in particular, between the user terminal emulation server 100, the I/O user device(s) 130 proximately located to a user, and the user tag transported by the user.

In some embodiments, the user, who has been registered and authenticated to a cloud service, carries a user tag which has been associated (e.g., by a user identity) to the user terminal emulation server 100 such in the database 120. As explained above, there can be numerous I/O user devices 130 that are associated and registered to a lookup service, e.g., IODH 212.

When a user enters the close proximity of at least one I/O user device 130, operations are performed based on Extensible Authentication Protocol (EAP), Authentication and Key Management for Applications (AKMA), or another security function to establish a secure association between the user terminal emulation server 100, the I/O user device(s) 130 proximately located to the user, and the user tag transported by the user. The secure association enables the user terminal emulation server 100 to utilize the UI capabilities of those I/O user device(s) 130 to obtain a communication service.

In some example scenarios, the user tag is transported by a user to identify the user and can be capable of short-range radio signalling, e.g., NFC, RFID, Bluetooth, etc., and/or log-range radio signalling, e.g., WiFi, cellular, etc. The user tag is registered and authenticated to the user terminal emulation server. At least one I/O user device 130 has a local service providing certain UI capabilities which can be registered with the user terminal emulation server 100 or IODH 212 for inclusion in a lookup service provided through a database, e.g., database 120 and/or which may reside in the IODH 212 and/or the I/O user devices 130.

Although some embodiments are described in the context of the user terminal emulation server 100 being a cloud-based service, these and other embodiments are not limited thereto. Operations disclosed herein can be used to enable an authenticated user to securely couple physical resources, residing on separate private networks, to a cloud-based service. The cloud-based service may be a phone service, video conference service, streaming media service, video on-demand service, audio on-demand service, web service, digital assistant service, service technician service and/or any other service which may operate to communicatively connect to physical resources in the proximity of a user.

Various embodiments are now separately explained in the context of EAP-based authentication operations and the context of AKMA-based authentication operations, although the operations may be used with any security function operations which can facilitate secure access. In some embodiments, the user terminal emulation server 100 performs operations to establish a secure channel connection with a first I/O user device 130 using a session identifier and an identifier associated with the first I/O user device to determine a first I/O user device specific key generated from a master key, the first I/O user device specific key and the session identifier being used for authentication and secure communication of messages with the first I/O user device. The operations receive an indication of an I/O user interface capability of the first I/O user device 130 through the secure channel connection with the first I/O user device 130. The operations communicate with the first I/O user device 130 to use the I/O user interface capability to provide at least part of the communication service for a user.

These and other related operations are first described in the EAP-based authentication context and then described in the AKMA-based authentication context.

### EAP-Based Authentication and Related Operations are Now Discussed Below.

EAP is an authentication framework which supports multiple authentication methods. EAP typically runs directly over data link layers such as Point-to-Point Protocol (PPP) or IEEE 802, without requiring IP. EAP provides its own support for duplicate elimination and retransmission but is reliant on lower layer ordering guarantees. Fragmentation is not supported within EAP itself; however, individual EAP methods may support fragmentation.

EAP is a two-party protocol spoken between the EAP peer and server. Within EAP, keying material is generated by EAP authentication algorithms, known as “methods”. Part of this keying material can be used by EAP methods themselves, and part of this material can be exported. In addition to the export of keying material, EAP methods can also export associated parameters such as authenticated peer and server identities and a unique EAP conversation identifier, and can import and export lower-layer parameters known as “channel binding parameters”, or simply “channel bindings”.

From RFC 5247: “EAP methods supporting key derivation and mutual authentication SHOULD export a method-specific EAP conversation identifier known as the Session-Id . . . ”. Exporting can entail providing the exported information to the EAP authenticator.

An example, flow of an EAP exchange for access authentication (802.1x used for WLAN/LAN), can include the device attaching to an authenticator point (AP). This means an (e.g.) 802.11 association is established between device and AP. The AP requests the identity of the device with an EAP identity request message. The device replies with its identity in an EAP response message. The AP, which works as an Authenticator, forwards the identity in a RADIUS or DIAMETER access request message to the authentication server.

The authentication server replies with a challenge for the device and indicating the EAP method to be used. The AP forwards the request in an EAP request message to the device. The device responds to the EAP message with an EAP response message. The AP forwards the response in a RADIUS or DIAMETER message to the authentication server. EAP messages are exchanged between the device and the authentication server until the authentication server has authenticated the device using the chosen method. The authentication server sends a RADIUS or DIAMETER access accept message, containing a pairwise master key (PMK) to the AP. The AP keeps the PMK and forwards the success in an EAP success message to the device. The device generates the corresponding PMK. The device is authenticated and the AP and device can use the PMK to configure access security. EAP can also be run towards Authenticators other than WLAN APs, and the Authenticator can be co-located with/part of the Authentication server.

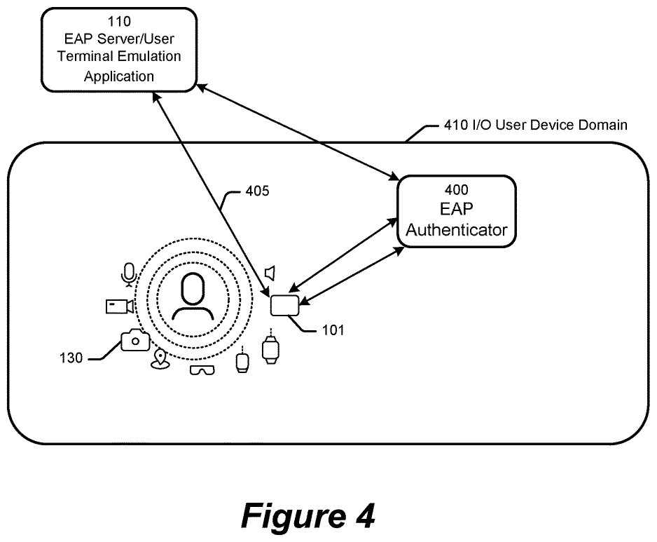

EAP-based operations between a user tag 110 and the user terminal emulation server 110, which can operate an EAP server (function), are now described with reference to FIG. 4. FIG. 4 illustrates a combined flowcharts of operations and related data flows between the user terminal emulation application 110 and elements of an I/O user device (IOD) domain 410, such as I/O user devices 130, a lookup service/IODH, and an Extensible Authentication Protocol (EAP) authenticator 400 in accordance with some embodiments of the present disclosure. For brevity when discussing various example operations below, the term “I/O device” is abbreviated as “IOD”.

Referring to FIG. 4, an assumption in the EAP-based approach is that the user tag is transported with the user and contains circuitry which is configured to operate as an EAP client. The user tag therefore has at least limited communication and computational capabilities. An example user tag can be a smart card with NFC, RFID, or other very short-range communication such as capacitive communication coupling, or can be an electronic device with Bluetooth and/or other communication capabilities. The I/O user devices 130 are registered with their (local) IODH 212, which functions as a lookup service for I/O user devices (IOD A . . . IOD x) in the local IOD domain 410, i.e., the IODH 212 has information characterizing the I/O user devices (IOD A . . . IOD x) which may include an identifier, authentication credentials (e.g. public key of I/O user devices (IOD A . . . IOD x), location of I/O user devices (IOD A . . . IOD x) geographic coordinates, room numbers, floor numbers, etc., defining type information, defining UI capabilities, etc. In some embodiments, the user terminal emulation application 110 may be executed within the IOD Domain 410, such as with the EAP Authenticator 400 and/or the IODH 212. Executing the user terminal emulation application on the same computing node or on a locally networked node as the EAP authenticator and/or IODH can simplify and reduce system resources consumed to exchange information and other communications therebetween.

Which users and/or user terminal emulation applications are allowed to interact with the I/O user devices (IOD A . . . IOD x) in the IOD domain 410 can be determined based on access control policies which can reside in the IODH 212 and may vary depending on use case scenario, e.g., semi-public domain, such as a hotel vs. private domain such as an enterprise office complex.

As will be explained below with regard to FIGS. 4 and 5, operations establish 405 (FIG. 4) and 511 (FIG. 5) a secure channel connection with a first I/O user device (130) using a session identifier and an identifier associated with the first I/O user device to determine a first I/O user device specific key generated from a master key, where the first I/O user device specific key and the session identifier being used for secure communication of messages with the first I/O user device.

In the scenario of FIGS. 4 and 5, a user who is transporting a user tag 101, e.g., dongle, wants to utilize a proximately located I/O user device (IOD A). The user may trigger the I/O user device (IOD A), by pushing a button on the user tag 101, triggering a command responsive to the user tag seeing a Service Set IDentifier (SSID) or Bluetooth (BT) address of the I/O user device (IOD A), and/or the I/O user device (IOD A). For example, the user may activate or initiate attention from the I/O user device (IOD A) using the user tag over NFC or RFID (i.e., very close proximity), and/or by the user pushing a button on the I/O user device to initialize a bootstrapping process 501. Alternatively the user tag can broadcast a beacon signal which can be heard by an I/O user device and which will trigger the authentication.

The user tag sends 502, via the I/O user device (target), an attach request to the system where the I/O user device is connected. The attach request is forwarded 503 by the I/O user device to the EAP Authenticator 400 in the system. The EAP authenticator 400 may be a local process in the I/O user device (IOD A) or in the IODH 212 of the user terminal emulation server 100, or may reside as a separate entity in the IOD domain 410. The attach request may therefore be processed by the I/O user device itself, i.e., where multiple EAP Authenticators are present in the system, be processed by the IODH 212, or be processed by the EAP authenticator 400.

The EAP authenticator 400 responds 504 with an EAP identity request, which is communicated back to the user tag 101.

The user tag 101 responds 505 with an EAP response, which carries the identity of the user tag 101. The identity identifies the user tag 101 (e.g., holder of user tag, such as the user) and points to the user terminal emulation application 110 associated with the user tag 10. The identity may be <hash (user_pub_key)>@<user_terminal emulation application_address>. The hash of the public key provides a more compact identity of the public key of the user tag 101, and may be included with a network address of the user terminal emulation application 110. As explained above, the user terminal emulation application 110 may provide a communication service function corresponding to, for example, an over-the-top Voice Over Internet Protocol (VOIP) service, Netflix service, Facebook service, Microsoft Teams meeting service, Internet browser service, a cellular communication service, etc.

When the user tag 101 has been issued to the user, it may have also been associated with the corresponding user terminal emulation application 110. This means that the user tag 101, in addition to its own credentials (e.g., public key pair), can be configured to have reachability information of the user terminal emulation application 110, e.g., a Fully Qualified Domain Name (FQDN), as well as credentials for authentication of the user terminal emulation application 110 (e.g., public key of user terminal emulation application 110). Likewise, the user terminal emulation application 110 may have been configured with the credentials of the user tag 101 (e.g., public key of user tag 101). This means that the user terminal emulation application 110 knows that the user tag 101 is an entity that is authorized to request data streams and services from the user terminal emulation application 110.

The EAP authenticator 400 identifies the user terminal emulation application 110 based on the realm part of the identifier and forwards the request to the user terminal emulation application 110, which is here acting as the EAP server (referred to as “EAP server/user terminal emulation application 110” for brevity).

The EAP authenticator 400 first establishes 506a secure connection between itself and the EAP server/user terminal emulation application 110. The EAP messages are passed over that secure channel between authenticator and EAP server/user terminal emulation application 110. The secure connection may be a Transport Layer Security (TLS) session. The EAP Authenticator 400 knows it needs to talk with the EAP server/user terminal emulation application 110 based on the identity (realm part of identity) received 506b in EAP Identity Response. It also knows it needs to have a secure channel with the EAP server/user terminal emulation application 110. Thus, if there is not an existing secure session (typically TLS), the EAP Authenticator 400 creates the secure session and then forwards 506b the Identity response to the EAP server/user terminal emulation application 110. The communication between the EAP Authenticator 400 and the EAP server/user terminal emulation application 110 function of the user terminal emulation application 110, while using EAP messages, may be carried by DIAMETER or RADIUS protocol.

The user terminal emulation application/EAP server 110 and the user tag 101 will perform an EAP exchange 507 to authenticate the user tag 101 to the user terminal emulation application 110. The EAP server/user terminal emulation application 110 may also be authenticated to the user tag 101. The authentication may require multiple messages to be exchanged between the user tag 101 and the EAP server/user terminal emulation application 110 via the EAP authenticator 400.

Once the user tag 101 and possibly also the EAP server/user terminal emulation application 110 is/are successfully authenticated, the EAP server/user terminal emulation application 110 can send 508 a final EAP SUCCESS message to the EAP authenticator 400. The EAP SUCCESS message also carries the master key, e.g., pairwise master key (PMK), and the session-ID. The PMK key is the master key for the session-ID, the PMK key can be used to derive more keys for I/O user devices, e.g., IOD X, added to this session.

In an optional operation, the user tag 101 at this stage may derive the master key, e.g., PMK key, but it will not (necessarily) be used by the user tag 101. The master key can be used if the user wants to authorize additional I/O user devices, e.g., IOD X, assuming the user is more in control of which I/O user devices are added to the session by having to actively (possibly even physically) add more I/O user devices to the EAP server/user terminal emulation application 110.

The authenticator generates 509 an I/O user device specific key K_iodA from the received keying material to be used for streaming data between user terminal emulation application 110 and the target I/O user device IOD A. Generating the I/O user device specific key K_iodA may include using the received keying material as is, or may include performing a computational operation on the received key material such as by hashing a concatenation of the keying material and the identifier of the target I/O user device IOD A and/or using another key derivation function (KDF) based on PMK and I/O user device specific information.

The EAP authenticator 400 provides 510 the I/O user device specific key K_iodA to the I/O user device IOD A, together with the session-ID exported by the EAP server/user terminal emulation application 110 and the address (e.g. FQDN) of the user terminal emulation application 110.

The I/O user device IOD A can use the received data to establish 511 a secure channel (e.g., TLS) between itself and the user terminal emulation application 110. It is noted that in some embodiments, to establish the secure channel between I/O user device IOD A and the EAP server/user terminal emulation application 110 there needs to be a shared secret (which is the first I/O user device specific key K_iodA), an identifier for who is connecting to the EAP server/user terminal emulation application 110 (IOD A) and that is used to derive I/O user device specific key, and an identifier (session-ID) that the EAP server/user terminal emulation application 110 can use to lookup the context from where it can derive the corresponding K_iodA.

If the EAP Authenticator 400 is part of I/O user device IOD A, then the I/O user device could re-use the TLS session established in operation 506. However, a more scalable solution is enabled by using a uniform operation for all I/O user devices connecting to the EAP server/user terminal emulation application 110 so as to not have special cases in an implementation.

In operation 511, the I/O user device IOD A can use the session-ID to indicate to the EAP server/user terminal emulation application 110 the session/keying material/authentication context to which the connection request relates.

The EAP server/user terminal emulation application 110 locates context and associate keying material based on received session-ID. As background, the IOD A is to connect with the EAP server/user terminal emulation application 110 using a secure channel so the EAP server/user terminal emulation application 110 can stream or receive data from the IOD A, such that the IOD A needs to have keying material which it can use to establish a secure connection and the user terminal emulation application 110 needs to verify that the IOD A is authorized to send data. So, the session ID that was sent in operation 508 is what the IOD A can send to the EAP server/user terminal emulation application 110 so it knows the request relates to the authentication session that was setup for the session ID, and then locates its copy of the PMK key and any other keys negotiated during the authentication.

The I/O user device uses its own identifier (e.g. IOD A) as a kind of username. The IOD A thereby tells the EAP server/user terminal emulation application 110 who it is. The EAP authenticator 400 has derived an IOD A specific key based on the PMK key, e.g., by concatenating the IOD A ID and the PMK key and then hashing the concatenated string, and may truncate the hash value to a defined length. The EAP server/user terminal emulation application 110 needs to know the ID for the IOD A so it can derive the same IOD A specific key provided to IOD A in, e.g., step 510.

The EAP server/user terminal emulation application 110 uses the I/O user device identifier to derive IOD A specific key (K_iodA). The IOD A uses the received key K_iodA as the password/authentication credential to authenticate to the EAP server/user terminal emulation application 110. In this operation the I/O user device IOD A and the EAP server/user terminal emulation application 110 share the same IOD A specific key which is used as a shared secret that the EAP server/user terminal emulation application 110 and I/O user device IOD A use to authenticate each other and establish a secure channel therebetween. The EAP server/user terminal emulation application 110 verifies, via PSK-based authentication, that the I/O user device indeed possesses a valid session key (K_iodA) and is thus authorized to connect to the EAP server/user terminal emulation application 110 and exchange data with it. A secure channel is established between the I/O user device IOD A and the EAP server/user terminal emulation application 110.

The I/O user device IOD A, after successful authentication, can indicate 512 its UI capabilities (e.g., display, speaker, microphone, etc.) to the user terminal emulation application 110, which based on the UI capabilities, can enable data streaming to and/or from the I/O user device IOD A.

The user may have defined policies to the EAP server/user terminal emulation application 110 regarding what operations can be enabled automatically (e.g., streaming video to a display device for the communication service) and what operations requires explicit user consent before performing (e.g., to enable microphone use for the communication service)

In a parallel optional operation, the EAP server/user terminal emulation application 110 may operate to interact 513 with the IODH 212 regarding other I/O user devices in the vicinity of the user which have UI capabilities that can be used to provide the communication service to the user. These operations can provide the EAP server/user terminal emulation application 110 information about what UI and/or I/O capabilities could be available to the user for the communication service. Whether the EAP server/user terminal emulation application 110 may operate to interact 513 with the IODH 212 regarding other I/O user devices may depend on which service and/or application is running in the EAP server/user terminal emulation application 110.

This communication may be performed via an entity of the I/O user device domain 410 acting as an EAP authenticator 400 towards the EAP server/user terminal emulation application 110, and thereby the already established secure channel could be re-used. Alternatively, the EAP authenticator 400 may generate an IODH 212 specific session key (similar to what was performed for IOD A) and provide IODH 212 with all relevant info (e.g., K_iodh, session-ID, EAP server/user terminal emulation application 110 FQDN) for securely communicating with the user terminal emulation application 110.

The IODH 212 may itself be the EAP authenticator 400, in which case much of the “communication” between authenticator and IODH 212 is simplified, such as where the PMK is used directly by the IODH 212 to securely communicate with user terminal emulation application 110, or the already established secure session is re-used.

The communication may include the IODH 212 telling the user terminal emulation application 110 about which I/O user devices are available to the user, and may include the EAP server/user terminal emulation application 110 requesting certain hardware resources from the IODH 212.

When the IODH 212 concludes, or the EAP server/user terminal emulation application 110 requests, that a certain other I/O user device (IOD X) should join the session established between the user and the IOD domain 410, the IODH 212 can request 514a the EAP authenticator 400 to generate credentials for the other I/O user device (IOD X), (e.g., K_iodx, session-ID, EAP server/user terminal emulation application 110 FQDN) and provide those credentials to the other I/O user device (IOD X).

The IODH 212 may send 514a a request based on the user instructing the EAP server/user terminal emulation application 110 (e.g., over connection with some already connected I/O user device) or based on local policy and/or configuration. The decision that a further I/O user device is required may be dependent upon: which application and/or service the user activates; ongoing application and/or service; available devices and their respective UI capabilities; and/or a defined configuration by the user to always try to find an I/O user device which has certain UI capability or capabilities.

If the other I/O user device IOD X receives 514c a trigger (e.g., where the trigger is the credentials etc. needed to connect to user terminal emulation application 110) from the IODH 212 or EAP authenticator 400, the other I/O user device IOD X performs similar operations to the I/O user device IOD A as described above in operations 511 to 512.

More general operations are now described with respect to FIGS. 4 and 5.

Embodiments are not limited to the particular operations illustrated in FIG. 5 and discussed above. For example, the user tag 101 can more generally include circuitry that is configured to send 502 to a first I/O user device 130 (which may correspond to IOD A) an attach request, and receive 504 from the first I/O user device 130 an identity request by an authenticator 400. The user tag 101 then sends 505 to the I/O user device a response which contains an identifier of the user tag and an address of a user terminal emulation application 110 hosted by a user terminal emulation server 100. The user tag 101 then communicates 507 with the user terminal emulation application (110) to perform an exchange for mutual authentication and establish a master key used to generate one or more I/O user device specific keys.

The circuitry of the user tag 101 may be powered by NFC reader of the first I/O user device 130 to send 502 the attach request, to receive 504 the identity request, to send 505 the response, and to communicate 507 with the user terminal emulation application 110 to perform the exchange. The circuitry may be further configured to generate 505 the identifier of the user tag based on hashing a public key of the user tag.

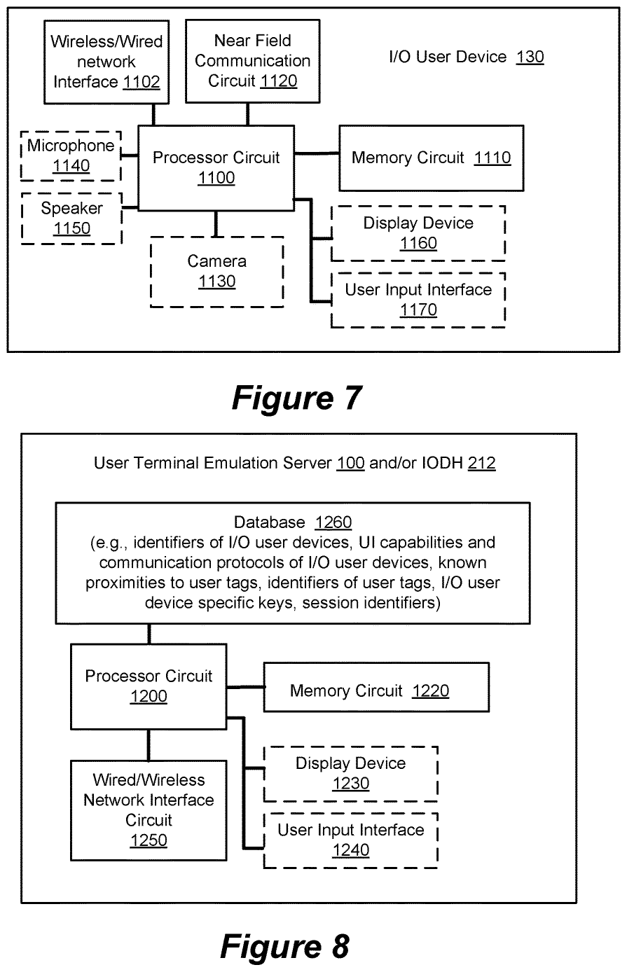

The user terminal emulation server 100 is generally configured to provide a communication service through I/O user devices 130, and includes at least one processor 1200 (FIG. 8) and at least one memory 1220 (FIG. 8) storing program code that is executable by the at least one processor to perform operations. The operations include to establish 405 (FIG. 4) and 511 (FIG. 5) a secure channel connection with a first I/O user device (130) using a session identifier and an identifier associated with the first I/O user device to determine a first I/O user device specific key generated from a master key, where the first I/O user device specific key and the session identifier being used for secure communication of messages with the first I/O user device. The first I/O user device specific key may be determined based on the I/O user device identifier, such as an I/O user device key (e.g., KDF (PMK, I/O user device ID), where KDF is a key derivation function). The operations receive 405 and 512 an indication of an I/O user interface capability of the first I/O user device 130 through the secure channel connection with the first I/O user device 130. The operations communicate 405 and 512 with the first I/O user device 130 to use the I/O user interface capability to provide at least part of the communication service for a user.

The operations by the EAP server/user terminal emulation application 110 can further include to receive 506b an EAP response through a communication channel with the EAP authenticator 400, where the EAP response contains an identifier of a user tag 101. The operations communicate 507 with the user tag 101 to perform an EAP exchange for authentication and establish the master key, and send 508 an EAP success message to the EAP authenticator 400, where the EAP success message contains the master key and a session identifier associated with the master key. Following the sending 508 of the EAP success message to the EAP authenticator 400, the operations perform the receiving 405 of the indication of the I/O user interface capability of the first I/O user device 130 and the communicating 405 with the first I/O user device 130 to use the I/O user interface capability to provide at least part of the communication service for the user.

The operations by the user terminal emulation server 100 can further include to store in the database 120 (FIG. 1) the identifier of the user tag allowed to access the communication service, a network address of the first I/O user device based on communications with the first I/O user device, the first I/O user device specific key, and the indication of the I/O user interface capability of the first I/O user device 130.

It is noted that initially the user terminal emulation server 100 (i.e., via the EAP server/user terminal emulation application 110) stores the session identifier and the PMK. When an I/O user device connects to the user terminal emulation server 100, the I/O user device provides its identifier to the user terminal emulation server 100 as part of the connection establishment procedure. The user terminal emulation server 100 can now generate the I/O user device specific key. Using the I/O user device specific key, the user terminal emulation server 100 can authenticate the I/O user device, and after (or as part of authentication) which can establish the secure channel between the two. The I/O user device has obtained the corresponding key from the EAP Authenticator 400 or the IODH 212 (if the EAP authenticator 400 sends the data via the IODH 212 to the I/O user device) in IOD domain 410. The I/O user device can likewise optionally authenticate the user terminal emulation application 110 using the key (i.e., verify that the user terminal emulation application 110 belongs in the session as it possesses a key associated with it). The I/O user device specific key can be generated by the user terminal emulation application 110 only after the user terminal emulation application 110 has learned the ID of the I/O user device specific key. In some embodiments, the EAP server/user terminal emulation application 110 learns the I/O user device identifier when the I/O user device tries to connect to the EAP server/user terminal emulation application 110.

In some embodiments, the order of events includes the I/O user device connects to the EAP server/user terminal emulation application 110 (with own ID, session ID and the I/O user device specific key). The EAP server/user terminal emulation application 110 identifies session context based on session ID. The EAP server/user terminal emulation application 110 derives the I/O user device specific key (and maybe stores in in the database 120). The EAP server/user terminal emulation application 110 and the I/O user device authenticate based on the I/O user device specific key. A secure channel can then be setup based on the I/O user device specific key.

The operations to establish 405 the secure channel connection with the first I/O user device 130 using the session identifier and the identifier associated with the first I/O user device to determine the first I/O user device specific key generated from the master key, can include to receive a secure channel connection request which includes the identifier of the first I/O user device 130 and the session identifier, and initiate the determination of the first I/O user device specific key based on the master key. The operations store the first I/O user device specific key in the database 120 with an association to the session identifier. The operations obtain the first I/O user device specific key from the database 120 using the session identifier, authenticate the first I/O user device based on the first I/O user device specific key, and setup the secure channel connection with the first I/O user device 130 responsive to authentication of the first I/O user device.

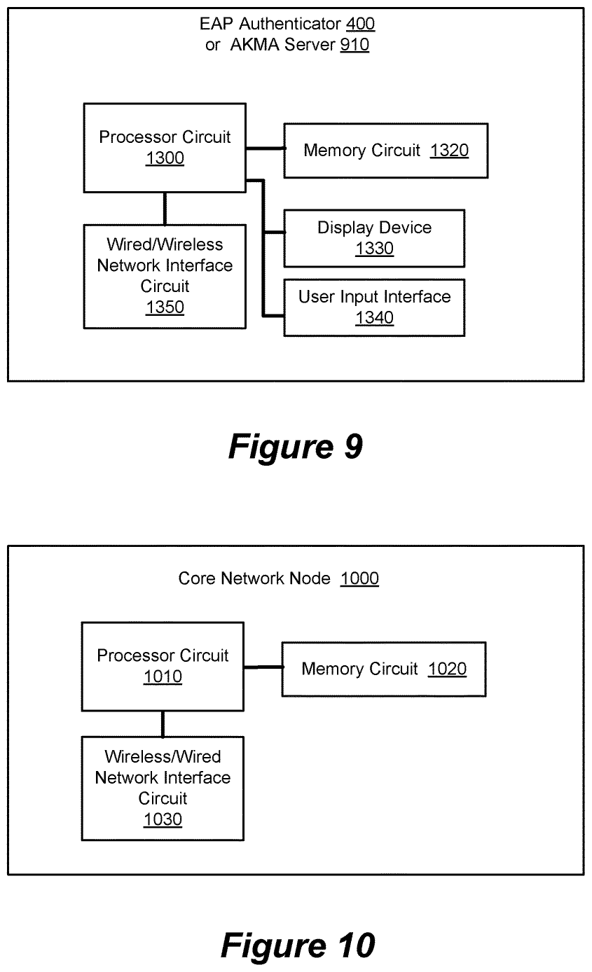

Corresponding operations by the EAP authenticator 400 are now described. The EAP authenticator 400 can include at least one processor 930 (FIG. 9), at least one memory 940 (FIG. 9) storing program code that is executable by the at least one processor to perform operations. The operations include to receive 505, from the first I/O user device 130, an EAP response which contains the identifier of the user tag containing an address of a user terminal emulation application 110 hosted by a user terminal emulation server 100. The operations establish 506a a communication channel with the user terminal emulation application 110 based on the address in the user tag of the user terminal emulation application 110, and send 506b at least one EAP message based on the EAP response through the communication channel with the user terminal emulation application 110. The EAP authenticator 400 also receives EAP messages from the user terminal emulation application 110. In general, the EAP Authenticator 400 passes EAP messages between the user tag 101 and the user terminal emulation application 110. The operations receive 508 an EAP success message from the user terminal emulation application 110, where the EAP success message contains a master key and a session identifier, and generate 509, based on the master key, a first I/O user device specific key. The operations then send 510 to the first I/O user device 130, e.g., via the IODH 212, the first I/O user device specific key, the session identifier, and the address for the user terminal emulation application 110.

The at least one EAP message may be sent 506b through the secure channel connection to the user terminal emulation application 110 using DIAMETER protocol or RADIUS protocol. The EAP authenticator 400 exchanges EAP messages between the user tag 101 and the user terminal emulation application 110 . . .

The EAP authenticator 400 may generate 509 the first I/O user device specific key based on a key derivation function performed on the master key and an identifier of the first I/O user device 130.

The EAP authenticator 400 may obtain 513 an identifier of a second I/O user device 130 that is proximately located to the first I/O user device 130 and has an I/O user interface capability that satisfies a rule for being combinable with the I/O user interface capability of the first I/O user device 130 to provide a communication service, and generate 514b, based on the master key, a second I/O user device specific key. The EAP authenticator 400 may can then send 510 to the second I/O user device 130, e.g., via the IODH 212, the second I/O user device specific key, the session identifier, and the address for the user terminal emulation application 110.

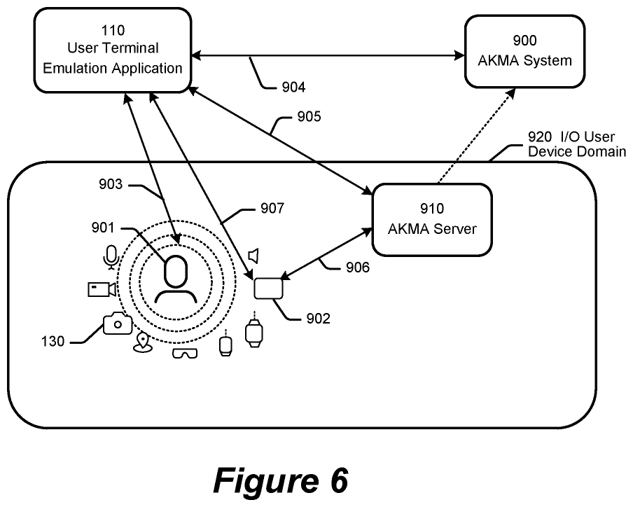

Corresponding operations by the first I/O user device 130 are now described. The first I/O user device 130 can include at least one processor 1100 (FIG. 7), and at least one memory 1110 (FIG. 7) storing program code that is executable by the at least one processor to perform operations. The operations include to receive 502 from a user tag an attach request, and forward 503 the attach request to an authenticator 400. The operations forward 504 to the user tag an identity request received from the authenticator 400, and forward 505 to the authenticator 400 a response received from the user tag, the response which contains an identifier of the user tag containing an address of a user terminal emulation application 110 hosted by a user terminal emulation server 100. The operations receive 510 from the authenticator 400 a message comprising a first I/O user device specific key for the first I/O user device 130, a session identifier, and the address for the user terminal emulation application 110. The operations establish 511 a secure channel connection with the user terminal emulation application 110 using the first I/O user device specific key and the session identifier received from the authenticator 400. The operations send 512 an indication of an I/O user interface capability of the first I/O user device to the user terminal emulation application 110 through the secure channel connection. The operations communicate 512 with the user terminal emulation server 100 to use the I/O user interface capability of the first I/O user device 130 to provide at least part of a communication service to a user.

The operation to establish 511 the secure channel connection with the user terminal emulation application 110 using the first I/O user device specific key and the session identifier received from the authenticator 400, may include sending the session identifier and an identifier of the first I/O user device to the user terminal emulation application 110 to indicate which I/O user device specific key is to be used to establish 511 the secure channel connection.

Utilizing authorization tokens and related operations are now discussed below.

In operation 508 above, when the user tag 101 has authenticated itself towards the EAP server/user terminal emulation application 110 using EAP, the user tag 101 now also possesses the session keying material. Using this, the user tag 101 may generate authorization tokens for other IODs, e.g., IOD X, that the user tag 101 wants to add to the currently ongoing session.

These operations may be an alternative to having the EAP Authenticator 400 or the IODH 212 delegate session keys to the I/O user devices. The token may, e.g., be a signed piece of data contain things such as the session ID (so that the EAP server/user terminal emulation application 110 can map the token to the session), the newly selected I/O user devices identity (so that EAP server/user terminal emulation application 110 can verify that the correct I/O user device is using the token) and possible a lifetime of the token.

The user tag 101 may provide such token (and a pointer to the EAP server/user terminal emulation application 110) to selected I/O user devices, which could then connect to the EAP server/user terminal emulation application 110 and present the token as proof of authorization by the user tag 101. The communication between user tag 101 and newly selected I/O user device may be similar to the initial registration to the IOD Domain 410 as described above starting with operation 501; the user tag 101 indicates it wants to connect the I/O user device IOD X to the EAP server/user terminal emulation application 110, but in a way that the I/O user device IOD X understands to reply with its identity.

As an example, when providing the user tag's identity in the EAP identity reply message, the user tag 101 may use the session ID as an identifier (or part of the identifier). The I/O user device IOD X itself, or the EAP Authenticator 400 may determine from the identifier a relation to an already ongoing session and which would result in providing the user tag 101 with the identity of the new I/O user device.

The identity of the I/O user device may be interpreted as an authentication challenge in an EAP method. The reply to the challenge may be the token generated by the user tag 101. The I/O user device IOD X may use the help of the EAP Authenticator 400 to verify that the token is valid (e.g., the EAP Authenticator 400 possesses the same keying material and can verify the signature), or may blindly trust the token and start using it towards the EAP server/user terminal emulation application 110.

These operations provide the user tag 101 and/or the user more control with respect to which I/O user device(s) are connected to the session as the user needs to select the used I/O user device(s). For proper trust in the tag by the EAP server/user terminal emulation application 110, the user tag 101 would also have a signature generated by the permanent credential of the user tag 101 towards the EAP server/user terminal emulation application 110 (or non-exported keying material of the EAP exchange, i.e. keying material not shared with the EAP Authenticator 400), since the EAP generated session key is also known to the EAP Authenticator 400, which therefor could generate a valid looking token even without the knowledge of the user.

Public vs private IOD domains and related operations are now discussed below.

The operations described above may be used in various scenarios such as in public locations (e.g., vacation resort/hotel) or private locations (e.g., enterprise office/complex). For these different types of scenarios there are differences with respect to access control requirements, such as for a public location (typically) anyone should be able to connect their cloud service (e.g., user terminal emulation application 110) to a public I/O user device, while in a private setting only authorized services/users would typically be allowed. This could be, e.g., the employees of a company being allowed to connect their user terminal emulation application 110 to I/O user devices in the office building. Alternatively, a mixed model may be provided where certain I/O user devices are accessible to anyone, while some other I/O user devices are only accessible to a subset of users and/or user terminal emulation applications 110.

Controller function and related operations are now discussed below.

A controller function in the IOD Domain 410 may be responsible for verifying that the connecting user terminal emulation application 110 is authorized to connect to the specified I/O user device. This could be a separate entity or a function of the IODH 212, which knows about all the I/O user devices in the domain 410. Alternatively, the controller function may be a part of the EAP Authenticator 400 or an Authentication and Key Management for Applications (AKMA) server, respectively (which in turn may be part of IODH 212, or be separate entities/functions).

When a user terminal emulation applications 110 or user is being authenticated to an AKMA server or the EAP Authenticator 400, the I/O user device Domain controller (IDC) can operate to verify that the connecting identity (tag identity authenticated with EAP, user terminal emulation applications identity learnt during EAP while setting up secure channel to user terminal emulation applications 110, or user terminal emulation applications identity learnt during AKMA authentication) is authorized to access services in the IOD Domain 410, and the target I/O user device specifically. If there are access control policies which indicate that the user and/or user terminal emulation applications 110 is not allowed, the controller function can operate to terminate the authentication and may provide some error code indicating the user and/or service is not authorized.

3GPP Key agreement method and related operations are now discussed below.

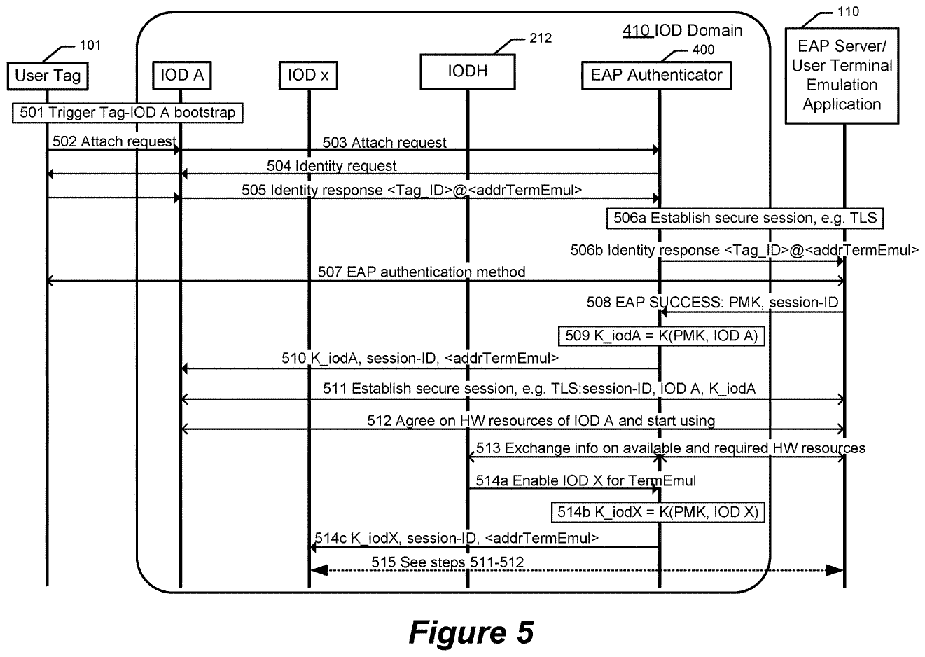

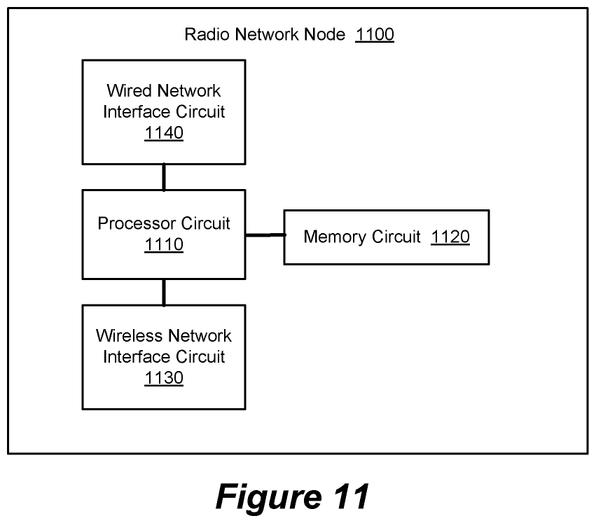

A 3GPP key agreement function for providing a communication service through a user terminal emulation application to I/O user devices in an I/O user device domain 920 is now described. Various operations are described in the context of AKMA and GBA, but are not limited thereto. FIG. 6 illustrates a combined flowchart of operations and related data flows between a user tag, I/O user devices, a 3GPP key agreement function system (which may be an AKMA system or Generic Bootstrapping Architecture system), and a user terminal emulation server 110 in accordance with some embodiments of the present disclosure. FIG. 10 illustrates a flowchart of operations that may be performed by the user terminal emulation server 110 in accordance with some embodiments.

Referring to FIG. 6, a user 901 selects a target I/O user device 902 and obtains therefrom an I/O user device identifier. For example, the user may scan an I/O user device identifier, such as by scanning a QR code, reading an identifier from a sticker on the I/O user device and entering the identifier into the user's own input device, using NFC or RFID to read the identifier from the I/O user device, etc. The user tag and I/O user device may include circuitry configured to utilize one or more communication protocols to communicate information described herein The I/O user device identifier can include an identifier of the I/O user device (IOD_ID) and an IOD Domain identifier, e.g. screen123@myioddomain.com.

The user 901 connects 903 to and authenticates to user terminal emulation application 110 (own cloud-based service). The I/O user device, or IOD Domain, may provide communication connectivity, e.g., over Bluetooth, Bluetooth Low Energy (BLE), WiFi, NFC, RFID, etc. or the user device and/or user tag may be configured with its own communication connectivity. Once the user terminal emulation application 110 has authenticated user/tag, the user 901 provides the obtained IOD ID to user terminal emulation application 110.

The user terminal emulation application 110 generates mobile subscription/SIM based credentials for use towards services by interacting 904 with the AKMA system 900 or a Generic Bootstrapping Architecture (GBA) function in the mobile operator. A result of the interacting 904 is that the user terminal emulation application 110 and the mobile operator, e.g., AKMA or GBA function, has a shared master AKMA secret key or shared master GBA secret key, and has an identifier for the context or key.

The user terminal emulation application 110 connects to the IOD Domain (e.g., AKMA Server) based on the I/O user device identifier (received in operation 903) realm part (e.g., myioddomain.com). The user terminal emulation application 110 derives an IOD Domain (e.g., AKMA Server 910) specific key from the AKMA or GBA master secret key. The user terminal emulation application 110 provides the AKMA or GBA context identifier to IOD Domain (e.g., AKMA Server 910). The IOD Domain (e.g., AKMA Server 910) uses the received AKMA or GBA context identifier to obtain IOD Domain specific AKMA or GBA key from the mobile operator AKMA or GBA function (e.g., AKMA Server 910), which may require pre-existing SLA/trust relationship between the IOD Domain and the mobile operator hosting the AKMA System. The user terminal emulation application 110 and the IOD Domain (e.g., AKMA Server 910) authenticate using the IOD Domain specific AKMA or GBA key, which may use a created secure session for further communication.

The user terminal emulation application 110 tells 905 the IOD Domain which I/O user device (e.g., screen123) it wants to interact with, e.g., based on the I/O user device identifier received in operation 903. The user terminal emulation application 110 also provides a pointer to itself, e.g., IP address, FQDN, etc.

The IOD Domain 920 (e.g., AKMA Server 910) generates 906 an IOD specific AKMA or GBA session key from the IOD Domain specific AKMA or GBA key and the I/O user device identity, which may be similar to how in the EAP example above an IOD specific key is derived from EAP PMK and provides the IOD specific key to the I/O user device. The IOD Domain 920 (e.g., AKMA Server 910) may also provide a pointer to the user terminal emulation application 110, and an AKMA or GBA context identifier.

The I/O user device connects 907 to the user terminal emulation application 110 based on received info. The I/O user device indicates the AKMA or GBA context identifier to the user terminal emulation application 110. The user terminal emulation application 110 can locate the AKMA or GBA context (e.g., AKMA or GBA master key). The I/O user device indicates its identity to the user terminal emulation application 110. The user terminal emulation application 110 can use the I/O user device identity together with the IOD Domain specific AKMA or GBA key to derive IOD specific AKMA or GBA session key. The user terminal emulation application 110 and the I/O user device can mutually authenticate using the I/O user device specific AKMA or GBA session key. The user terminal emulation application 110 and the I/O user device can use key to further establish a secure channel between themselves for streaming data for the communication service.

The operations by the user terminal emulation server 100 may more generally include, with reference to FIG. 9, to authenticate 903 an identifier of the user tag or a user, receive 903 the identifier of the first I/O user device. The operations generate 904 and 905 the first I/O user device specific key through communications with a 3GPP key agreement function.

The key agreement function may include one of: an AKMA function; a GBA function; and a Battery Efficient Security for very low Throughput Machine Type Communication function.

The operation to generate 904 and 905 the first I/O user device specific key through communication with the key agreement function, may include to generate the first I/O user device specific key based on processing the master key derived through the key agreement function.

The operations may further include to communicate with the 3GPP key agreement function, e.g., AKMA function, hosted in a mobile operator system to generate a shared secret between the user terminal emulation server 100 and the key agreement function.

Example I/O user device, user terminal emulation server, EAP authenticator or AKMA server, user tag, and IODH are now discussed below.

FIG. 7 is a block diagram of hardware circuit components of an I/O user device 130 which are configured to operate in accordance with some embodiments. The I/O user device 130 can include a wired/wireless network interface circuit 1102, a near field communication circuit 1120, at least one processor circuit 1100 (processor), and at least one memory circuit 1110 (memory). The processor 1100 is connected to communicate with the other components. The memory 1110 stores program code (e.g., user terminal emulation application(s) 110) that is executed by the processor 1100 to perform operations disclosed herein. The processor 1100 may include one or more data processing circuits (e.g., microprocessor and/or digital signal processor), which may be collocated or distributed across one or more data networks. The processor 1100 is configured to execute the program code in the memory 1110, described below as a non-transitory computer readable medium, to perform some or all of the operations and methods for one or more of the embodiments disclosed herein for a mobile electronic device. The I/O user device 130 can include one or more UI component devices, including without limitation, a microphone 1140, a speaker 1150, a camera 1130, a display device 1160, and a user input interface 1170.

FIG. 8 is a block diagram of hardware circuit components of a user terminal emulation server 100 and/or an I/O device handler (IODH) 212 which are configured to operate in accordance with some embodiments. The user terminal emulation server 100 and IODH 212 may reside on the same physical computing platform or may reside on different physical computing platforms which are communicatively networked together. The user terminal emulation server 100 and/or IODH 212 can include a wired/wireless network interface circuit 1250, a database 120 (e.g., any one or more of a listing I/O user devices, UI capabilities of the I/O user devices, communication protocols used to communicate with the I/O user devices, known proximities to user identifiers, identifiers of user tags, I/O user device specific keys, session identifiers, etc.), a display device 1230, a user input interface 1240 (e.g., keyboard or touch sensitive display), at least one processor circuit 1200 (processor), and at least one memory circuit 1220 (memory). The processor 1200 is connected to communicate with the other components. The memory 1220 stores instructions that is executed by the processor 1200 to perform operations disclosed herein. The processor 1200 may include one or more data processing circuits (e.g., microprocessor and/or digital signal processor), which may be collocated or distributed across one or more data networks. The processor 1200 is configured to execute computer program instructions in the memory 1220, described below as a non-transitory computer readable medium, to perform some or all of the operations and methods for one or more of the embodiments disclosed herein for a user terminal emulation server and/or an IODH.

FIG. 9 illustrates a block diagram of hardware circuit components of an EAP authenticator 400 or AKMA server 910 that are configured to operate in accordance with some embodiments of the present disclosure. The components can include a wired/wireless network interface circuit 950, a display device 960, a user input interface 970 (e.g., keyboard or touch sensitive display), at least one processor circuit 930 (processor), and at least one memory circuit 940 (memory). The processor 930 is connected to communicate with the other components. The memory 940 stores program instructions that are executed by the processor 930 to perform operations disclosed herein. The processor 930 may include one or more data processing circuits (e.g., microprocessor and/or digital signal processor), which may be collocated or distributed across one or more data networks. The processor 930 is configured to execute computer program instructions in the memory 940, described below as a non-transitory computer readable medium, to perform some or all of the operations and methods for one or more of the embodiments disclosed herein for a mobile electronic device.

FIG. 10 illustrates a block diagram of hardware circuit components of a core network node 1000 that are configured to operate in accordance with some embodiments of the present disclosure. The components can include a wired/wireless network interface circuit 1030, at least one processor circuit 1010 (processor), and at least one memory circuit 1020 (memory). The processor 1010 is connected to communicate with the other components. The memory 1020 stores program instructions that are executed by the processor 1000 to perform operations disclosed herein. The processor 1010 may include one or more data processing circuits (e.g., microprocessor and/or digital signal processor), which may be collocated or distributed across one or more data networks. The processor 1010 is configured to execute computer program instructions in the memory 1020, described below as a non-transitory computer readable medium, to perform some or all of the operations and methods for one or more of the embodiments disclosed herein for a core network node.

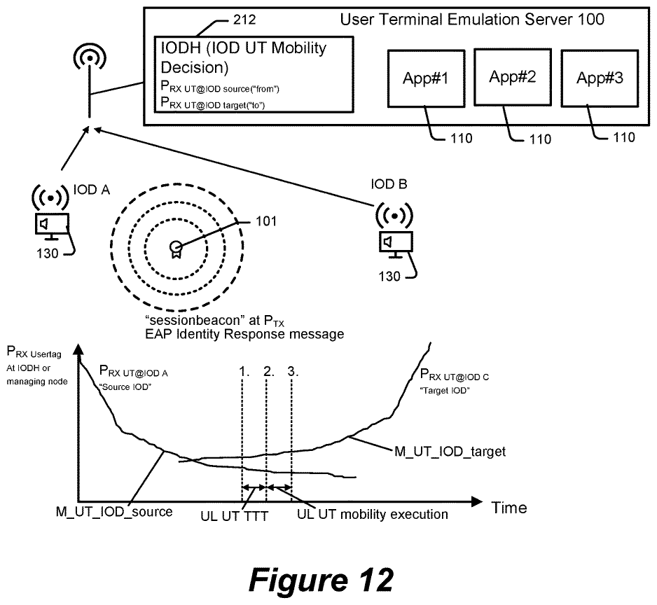

FIG. 11 illustrates a block diagram of hardware circuit components of a radio network node 1100 that are configured to operate in accordance with some embodiments of the present disclosure. The radio network node 1100 may correspond to, without limitation, an eNB, gNB, other 3GPP base station, WiFi access point, etc. The components can include a wired network interface circuit 1140, a wireless network interface circuit 1130, at least one processor circuit 1110 (processor), and at least one memory circuit 1120 (memory). The processor 1110 is connected to communicate with the other components. The memory 1120 stores program instructions that are executed by the processor 1110 to perform operations disclosed herein. The processor 1110 may include one or more data processing circuits (e.g., microprocessor and/or digital signal processor), which may be collocated or distributed across one or more data networks. The processor 1110 is configured to execute computer program instructions in the memory 1120, described below as a non-transitory computer readable medium, to perform some or all of the operations and methods for one or more of the embodiments disclosed herein for a radio network node.

Systems and operations for managing mobility of communication services across I/O user devices are now discussed below.

An IODH is responsible for managing mobility of communication services across I/O user devices responsive to mobility of user tags transported by users and/or the I/O user devices. Before discussing details of mobility management in accordance with some embodiments, an overview of 3GPP based mobility management and related Bluetooth and WiFi headset mobility are discussed.

Example 3GPP mobility management can include the following operations.

Event A3 is triggered when a neighbor cell becomes better than a special cell (SpCell) by an offset. A special cell is the primary serving cell of either the Master Cell Group (MCG) or Secondary Cell Group (SCG)). The offset can be either positive or negative. Measurement report management for LTE is described in Section 5.5 of 3GPP TS 36.331 Release 17, V17.1.0. Measurement report management for NR is described in Section 5.5 of 3GPP TS 38.331 Release 17, V17.1.0.

This event is typically used for intra-frequency or inter-frequency handover procedures. When Event A2 is triggered, the UE may be configured with measurement gaps to measure the inter-frequency objects and Event A3 for inter-frequency handover. Event A3 provides a handover triggering mechanism based upon relative measurement results, e.g., it can be configured to trigger when the Reference Signal Received Power (RSRP) of a neighbor cell is stronger than the RSRP of serving cell.

Trigger and cancel condition according to:

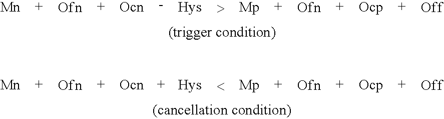

For example, consider A3-offset is set to as 3 dB, hys, Ofn, Ofp and Ocp are set to 0 dB. As soon as the UE found any neighbor cell whose measurements is 3 dB better than serving cell, it should report the Event A3; e.g. Neighbor cell RSRP=−78 dBm and Serving cell RSRP=−82 dBm, here neighbor cell is better and satisfy the Event offset, so UE will report Event A3 to the gNB.

In the above trigger condition and cancellation condition, the terms have the following meanings:
Mn is the measurement result of the neighboring cell, not taking into account any offsets.
Ofn is the measurement object specific offset of the reference signal of the neighbour cell i.e. offsetMO as defined within measObjectNR corresponding to the neighbour cell).
Ocn is the cell specific offset of the neighbor cell i.e. cellIndividualOffset as defined within measObjectNR corresponding to the frequency of the neighbor cell, and set to zero if not configured for the neighbor cell.
Mp is the measurement result of the SpCell, not taking into account any offsets.
Ofp is the measurement object specific offset of the SpCell i.e. offsetMO as defined within measObjectNR corresponding to the SpCell.
Ocp is the cell specific offset of the SpCell i.e. cellIndividualOffset as defined within measObjectNR corresponding to the SpCell, and is set to zero if not configured for the SpCell.
Hys is the hysteresis parameter for this event i.e. hysteresis as defined within reportConfigNR.
Off is the offset parameter for this event i.e. a3-Offset as defined within reportConfigNR.
Mn, Mp are expressed in dBm in case of RSRP, or in dB in case of RSRQ and RS-SINR

Related uplink-based handover procedures can include the following operations.

Many approaches have been provided in previous evolvements of mobile systems. There are several explanations why downlink reference symbol-based solutions where adopted, where amongst others where the historical lack high-capacity BS-BS and later on NodeB-NodeB and later on eNB-eNB fiber connection that would have enabled joint uplink “base station” reception. Although today's solutions have gigabit gNB-gNB connections, as systems “must have” backwards compatibility, these approaches are challenged by the downlink-based approach.

One rather recent suggestion porting LTE to UE-transmitted UL SRS-based mobility, includes where the UE transmits UL RSs which are received at the serving and, possibly, several neighboring BSs (n-BSs), allowing the network to perform UL signal strength measurements. These measurements are processed in a central network controller to make intelligent proactive decisions on which BS shall serve a given user. The realization of the UL-HO scheme comes with the requirement that the time synchronization between the BSs receiving the UL RS should be within some specified upper bound.

This requirement may already be in place to efficiently support other implementations such as TDD operation, joint uplink transmission, etc. in small cell deployments with very short propagation times. In addition, in order for a n-BSs to be able configuration parameters (timing, frequency, code, etc.) of such UL RS, which are set by the s-BS, are also shared with n-BS. This can be effectively achieved via existing interfaces (such as e.g., X2 or S1 in LTE) and would only require some minor standard upgrades in defining the information elements to be communicated between the BSs.

From a power control perspective, note that there is only a need for n-BSs to detect and measure the UL RS when the UE is approaching the cell border, i.e., where handovers take place. When this happens, the power control set by the s-BS should allow the UL RS to be received at the n-BS, since both the s-BS and n-BS become almost equidistant (in radio terms that is).

Furthermore, the detection of UL RS is rather robust since it is, by design, a known signal transmission, with known time, frequency, and code signatures and thus readily detectable and measurable at the n-BSs. The rest of the handover (HO) procedure remains the same as in LTE and NR starting from the HO preparation phase. By reusing the UL channel measurements from UL RSs (needed in, e.g., massive MIMO operation) also for mobility purposes requires no extra signaling overhead. Another benefit of using UL measurements for UE mobility is that it is possible to improve the network performance by network side upgrades without UE impact.

The network controller measurement processing can include where, as the UE moves through the network, the serving BS becomes weaker than the target BS. The serving, as well as n-BSs to detect and measure the UL RS, it is also required that the perform UL RS received power (UL-RSRP) measurements and these measurements are processed in a central network controller. If the UL-RSRP of the serving BS is less than a target BS by an offset called “A3 UL-offset”, and this condition is maintained during the time defined by “UL Time To Trigger (UL-TTT)”, the controller decides which BS shall serve the given UE. Based on the controller HO decision, the serving BS sends a HO request to the controller suggested target BS.

Example Bluetooth and WiFi headset mobility management can include the following operations.

WiFi access point mobility is typically device centric where a (proprietary, chipset specific) algorithm detects channel signal strength (quality) and evaluates if channel provided from one access point at some channel (e.g. 1,6,11 as orthogonal for 801.22b/g) provides better signal strength than some other access point. If that case is determined, device has to cease connection for the pre access point (i.e., halt application data flow) and resume communication at the new access point after legacy steps of authentication, association and handshake. There are managed solutions where network controller node(s) in more cellular manner supports selections, packer forwarding and WiFi node groupings.

Some problems that may arise if 3GPP, Bluetooth, or WiFi mobility management were to be attempted to be extended to the system architectures of FIGS. 1-6 are now described.

3GPP mechanisms cannot address experienced mobility challenge since they are based on e/gNB transmitted downlink reference symbol detection measured and evaluated by a UE and reported to a serving UE-e/gNB.

3GPP solutions also only addresses scenarios where a UE moves between different e/gNBs, not that a non-3GPP user-defining minimalistic device (user tag 101) e.g., operating over NFC, active/passive RFID or Bluetooth, etc., is moving between communicating with different UEs (I/O user devices 130).

Control-data plane termination in legacy solutions terminates in the UE, whereas in the architecture of FIGS. 1-6 the control plane terminates in the user tag and the data plane terminates in associated I/O user devices 130.

Prior mechanisms do not manage mobility based on providing certain user interface (UI) capability among the I/O user device(s) 130 used for a communication service to be provided or being provided to a user, and attempting to maintain continuity in the UI capability when performing handover between I/O user devices 130. For example, the disaggregated paradigm provided by current e/gNB-centric solutions cannot manage the UI capability (media type) and provide UI continuity for a communication service.

Operations enable an IODH to manage mobility of a user tag in communications with I/O user devices with respect to the user's relative (e.g., radio measure-based) locality and current user status (e.g., idle/active communications state). The IODH can be responsible for processing content of user tag beacon signal data, beacon signal filtering, beacon signal strength/threshold evaluations, and responsive application of mobility procedures.

In prior mobility paradigms, UE mobility is managed between e/gNBs where: reference signals are sent either by e/gNB (DL reference signals such as CRS, CSI-RS, DM-RS) or UE (SRS, UL); mobility principles are executed by e/gNB or a radio network control node(s); and the involved user (data) plane and control plane both terminates in the UE. In contrast to these prior mobility paradigms, operations according to various present embodiments involve: control plane terminating in the user tag; user (data) plane terminating in any of the I/O user devices which in their role simultaneously act as reception point for user tag beacon signals, and where mobility of the user tag between the I/O user devices can be managed by a central IODH based on attributes of a user tag beacon signal detected by multiple I/O user devices.

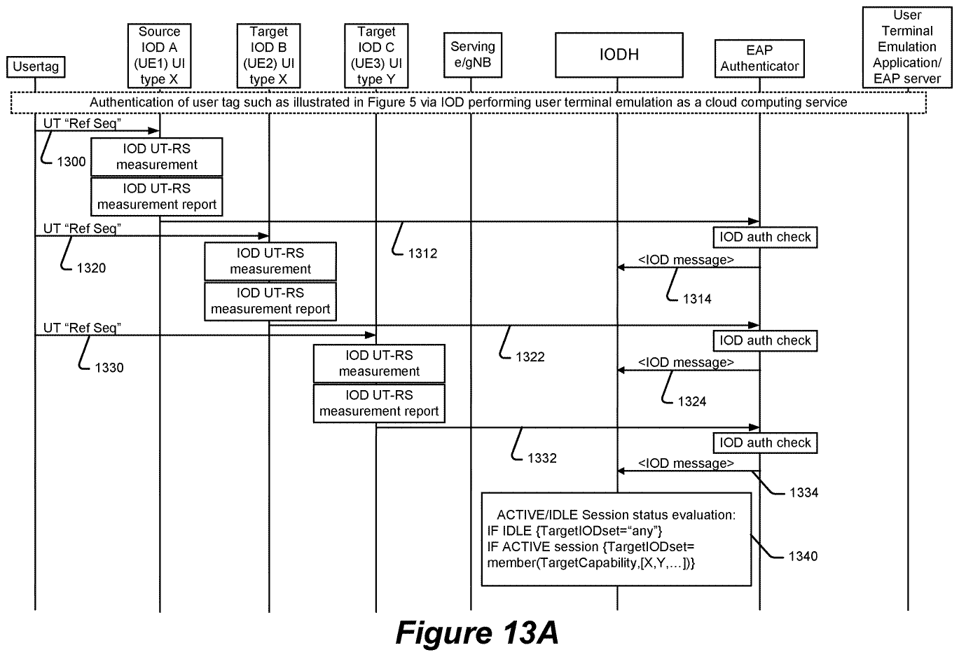

Some mobility management operations are now described in the context of a scenario where a user tag (UT) transmits a beacon signal containing session related information which is received by two I/O user devices (IOD A and IOD B) which are proximately located to the user tag (UT). FIG. 12 illustrates a mobility scenario and some related mobility management operations that can be performed by a IODH in accordance with some embodiments of the present disclosure.

Referring to FIG. 12, the example user terminal emulation server has three user terminal emulation applications 110, illustrated as App #1, App #2, App #3, which have been invoked and are being execution by the server 100. User tag 101 is transportable by a user and includes circuitry configured to perform an authentication process 1100 with an authenticator 400 (FIG. 4) or 910 (FIG. 6) via communications through an I/O user device IOD A 130 or IOD B 130 to obtain session related information. The term “user tag” is also shown as “Usertag” in the figures. The user tag 101 transmits a beacon signal containing the session related information to I/O user devices proximately located to the user tag 101.

In some further embodiments, the user tag circuitry may be configured to obtain the session related information based on an authenticated session identifier obtained through communications with the authenticator 400 for authentication. For example, the user tag may obtain the session related information from an EAP response message from the authenticator. The user tag may receive beacon configuration information from the I/O user device 130, and to transmit the beacon signal at an interval defined based on the beacon configuration information. The user tag may receive beacon configuration information from the I/O user device 130, and to transmit the beacon signal at a power level defined based on the beacon configuration information. As will be described in further detail below, the user tag may derive a key based on the authentication process with the authenticator 400, and transmit the beacon signal with secure communications protection using the key. These and other related embodiments of user tag operations are described in further detail below.

IOD A 130 and IOD B 130 are spaced apart in location and receive the beacon signal transmitted by the user tag 101, and each separately measures signal strength of the beacon signal to generate a beacon signal measurement. IOD A 130 and IOD B 130 each send the beacon signal measurement and the session related information for use by the IODH 212 for mobility management of a communication service for the user that can be provided by the user terminal emulation server 100. As explained below, the IODH 212 can use the beacon signal measurements to manage mobility of a communication service for one or more of the user terminal emulation applications 110, (App #1, App #2, App #3), such as by triggering switching of a communication stream that was being routed to IOD A 130 to instead being routed to IOD B 130.

In the illustrated scenario, a user tag uplink IOD-to-IOD event is determined by the IODH 212 to occur at time event “1”, illustrated in the graph of received power (“PRX Usertag”) versus time, based on the reported beacon signal measurements. In the illustrated graph, the beacon signal measurement by IOD A becomes a defined threshold (e.g., X dB) weaker than the beacon signal measurement by IOD B, which triggers handover. The operations may include use of one or more hysteresis threshold(s) to avoid unnecessary ping-pong switching back-and-forth, threshold offsets defining a level of signal strength improvement that needs to be observed before triggering a switch, and filtering (e.g., smoothing) that can be applied over time to a series of beacon signal measurements received from each of the IODs.

The illustrated subsequent time event “2” corresponds to a user tag IOD-IOD mobility evaluation Time-to-Trigger (TTT), which is after expiration of TTT the IODH 212 determines what IOD-to-IOD mobility is to be executed.

The further illustrated subsequent time event “3” corresponds to the IODH 212 initiating IOD A to IOD B mobility. The IODH 212 carries out authentication and IOD stream configuration, IOD B stream ADD (e.g., adding user terminal emulation application details: FQDN, K_IOD_B) to initiate routing of a communication stream to IOD B, and IOD A stream REMOVE to initiate ceasing of routing of the communication steam to IOD A. The ADD decision may be performed by the IODH 212, but the execution of the ADD event can optionally or typically flow through the EAP authenticator, and possibly signaled via the IODH 212. For example, the IODH 212 may request the EAP authenticator, or request the IODH 212 which requests the EAP authenticator, to add the IOD stream. It is noted that these operations can correspond to mobility handover, although other remove actions may be subject to IOD-handover, e.g., when a new IOD with required UI capability(ies) is detected. In such case, a longer hysteresis to remove IOD A or discontinue the communication stream may be needed. It is also noted that initiating routing of the communication stream to IOD B (i.e., handover IOD) may be delayed until the user is determined to be proximately located to IOD B, such as responsive to a camera of IOD B or another local I/O user device identifying presence of the user transporting user tag 101.

In some further embodiments, the I/O user device may be configured to directly or indirectly receive from the IODH 212 a message containing an instruction to add an I/O traffic stream associated with the session related information, and to initiate outputting and/or inputting through at least one I/O user interface of the I/O user device 130 content of the I/O traffic stream associated with the session related information between the I/O user device 130 and a user terminal emulation application 110. The I/O user device may be configured to receive from the IODH 212 a message containing an instruction to remove an I/O traffic stream associated with the session related information, and to cease outputting and/or inputting through at least one I/O user interface of the I/O user device content of the I/O traffic stream associated with the session related information between the I/O user device and the user terminal emulation application 110. The I/O user device may be configured to generate the beacon signal measurement based on a present measurement of signal strength of the beacon signal presently received from the user tag combined with at least one previous measurement of signal strength of at least one previously received beacon signal from the user tag. The combining of previous measurements of signal strength may include filtering as discussed below.

In some further embodiments, the operation by the I/O user device to send 1604 the beacon signal measurement and the session related information to the IODH 212 for mobility management, may include sending the beacon signal measurement for use by the IODH 212 at a periodic interval of length to receive a plurality of beacon signals from the user tag for use in generating the beacon signal measurement based on combining the measurements of signal strength of the plurality of beacon signals. The I/O user device may be further configured to trigger sending of the beacon signal measurement for use by the IODH 212 responsive to at least a threshold change in measurements of signal strength over a sequence of received beacon signals.

These and other related embodiments of I/O user device operations are described in further detail below.

According to some embodiments, mobility management operation can differ depending upon whether mobility is being performed for idle versus active user sessions. In an idle session, the user has no active data streams to and from a user terminal emulation application 110 and/or authenticator 400 (FIG. 4) or 910 (FIG. 6) to consider, although the IODH 212 can operate to keep track of location and beacon signal measurements for the user tag 101.

The IODH 212 for managing mobility of the communication service for a user through IOD A and IOD B (I/O user devices 130), can include circuitry configured to receive from IOD A and IOD B, the beacon signal measurement and session related information. As explained above, the beacon signal measurement indicates a signal strength measurement by the I/O user device (IOD A or IOD B) of a beacon signal from the user tag 101. The IODH 212 initiates mobility switching of an I/O traffic stream associated with the session related information from being routed between a user terminal emulation application 110 hosted by the user terminal emulation server 100 and IOD A to being routed between the user terminal emulation application 110 and IOD B, responsive to determining a mobility switching rule is satisfied based on comparison of the beacon signal measurements by the IOD A and IOD B.

The IODH 212 may be configured to initiate mobility switching of the I/O traffic stream by operations that include sending to a second I/O user device a message containing an instruction to add the I/O traffic stream associated with the session related information, and sending to the first I/O user device a message containing an instruction to remove the I/O traffic stream associated with the session related information.

The IODH 212 may be configured to receive the beacon signal measurement and the session related information for one of the I/O user devices 130 in a message that is sent by an authenticator 400 responsive to the authenticator 400 receiving and successfully authenticating content of the message from the one of the I/O user devices 130. The IODH 212 may be configured to receive the beacon signal measurement and the session related information in a message sent by one of the I/O user devices 130, and to authenticate content of the message based on a key obtained from an authenticator 400.

These and other related embodiments of IODH operations are described in further detail below.

As explained above for some embodiments, communications between the user tag 101 and the user terminal emulation application 110 can be routed through the EAP authenticator 400 for authentication. The user tag 101 and the user terminal emulation application 110 can share a first key. The user terminal emulation application 110 provides a second key to the EAP authenticator 400, and the user tag 101 locally derives from the first key the same second key. From the second key, the user tag 101 and the EAP authenticator 400 derive (e.g., among other keys) a third key (also referred to as a user tag specific key), which the user tag 101 uses to protect the beacon signal it transmits. The EAP authenticator 400 (or IODH 212 if the third key is shared to the IODH 212) verifies the beacon signal using the third key, where the beacon signal is measured by the I/O user device. The authentication protocol between the user tag 101 and the user terminal emulation application 110 is communicated through the I/O user device acting as an access point, but the I/O user device is not, in at least some embodiments, involved in the authentication process.

Referring to FIG. 9, the authenticator 400 includes circuitry configured to establish a key through an authentication process with the user tag 101 via a first I/O user device (e.g., IOD A). The authenticator 400 authenticates a beacon signal from the first I/O user device (IOD A) based on the key. The beacon signal is accompanied by a beacon signal measurement that indicates a signal strength measurement by the first I/O user device (IOD A) of the beacon signal from a user tag transportable by the user. The beacon signal is secured using the key. Responsive to authentication of the beacon signal, the authenticator 400 sends the beacon signal (at least part of the beacon signal) and the beacon signal measurement to the IODH 212 managing mobility of a communication service for a user through the IOD A and IOD B and/or other I/O user devices 130. The sending of the beacon signal by the authenticator 400 may correspond to sending session related information, e.g., Session ID, that can be received from the first I/O user device (IOD A) as part of the beacon signal.

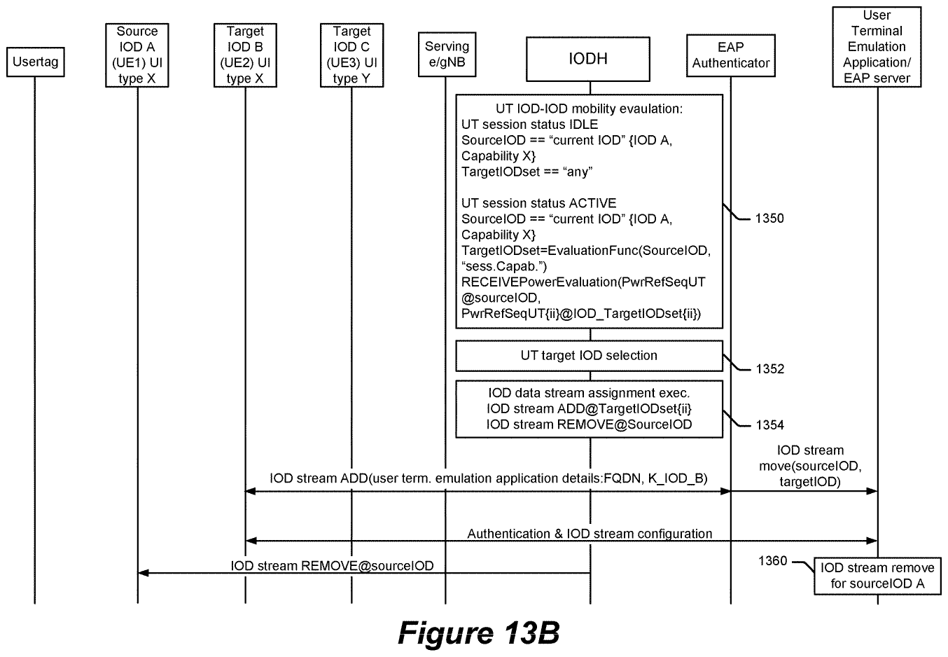

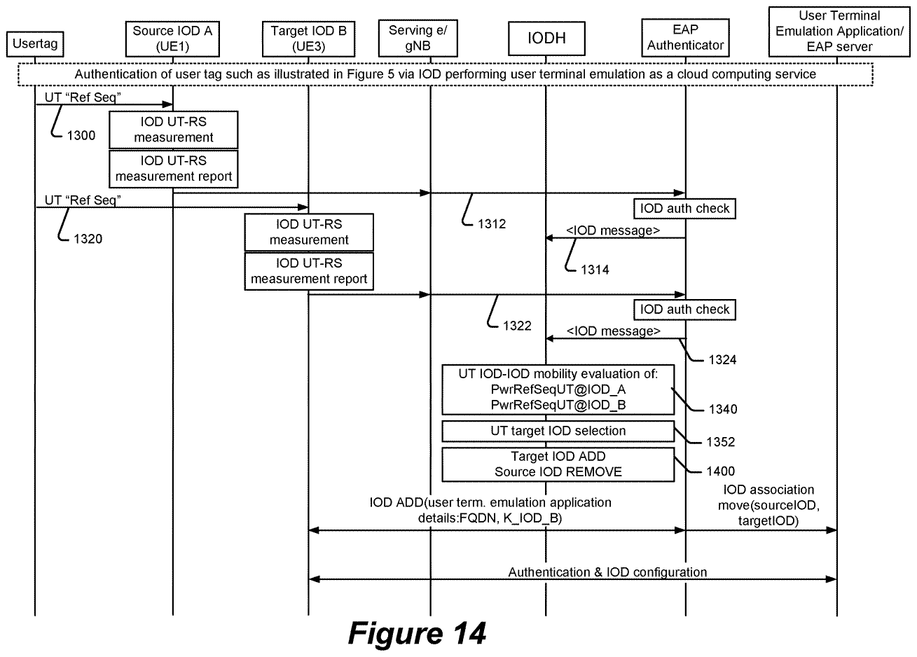

FIGS. 13A and 13B illustrate operations for mobility management of an active session in accordance with some embodiments of the present disclosure. FIG. 14 illustrates operations for mobility management during idle in accordance with some embodiments of the present disclosure. In FIGS. 13A, 13B, and 14 the term “IOD” refers to “I/O user device” for brevity. Although the illustrated embodiments are primarily directed to a scenario where the beacon signal measurement is routed from the I/O user devices through the EAP authenticator to the mobile manager, in some other embodiments the beacon signal measurement is routed from the I/O user devices to the IODH.

Referring to FIGS. 13A and 13B, the illustrated scenario provides mobility for an active user session where media content provided through the user terminal emulation application session (user terminal emulation application 110) is considered in the mobility evaluation to determine a valid target I/O user device. In this scenario the mobility evaluation can forego an I/O user device-set selection process before assessment of associated user tag Reference Sequence measurement reports provided from I/O user devices detecting said signal is executed. FIG. 14 illustrates the idle scenario. Similar operations illustrated in FIGS. 13A, 13B, and 14 have been labeled with the same reference number.

Although not explicitly illustrated in FIGS. 13A and 13B, the I/O user device UI capability can be a composite capability provided by a composite I/O user device, such as a display screen connected to a camera, and a corresponding “I/O user device-set” may include UI separate or combined (composite) capabilities (e.g., camera, display screen, microphone, speakers, etc.) and also contain corresponding UI capability entries (e.g., camera-screen, microphone-speakers, camera-screen-speakers).

In the context of mobility management, the illustrated scenario of control plane functionality terminates in the user tag, and the user (data) plane terminates in any of the I/O user devices.

In some embodiments, the control plane is terminated elsewhere than the user tag. In some embodiments, the user using an I/O user device to access a user terminal emulation application service (via a user terminal emulation application), can configure what I/O user device UI capability types are needed and then let the user terminal emulation application act on this configuration and request suitable I/O user devices from the IODH 212 (user terminal emulation server 100). The IODH 212 or user terminal emulation server 100 orchestrates selecting (based on the defined UI capability requirements) suitable I/O user devices for a session, select the I/O user devices based on being proximately located to the user or otherwise at correct locations based on the beacon signal strength measurements, e.g., network/user terminal emulation application 110 controlled addition of an I/O user device.

Referring to the active session scenario of FIGS. 13A and 13B, the user tag (“Usertag”) communicates through the IOD A to exchange information with the EAP authenticator and the user terminal emulation application to perform authentication operations such as described above with regard to FIG. 5. The operations may include the user tag sending a usertag attach request, receiving a user tag identity request, and providing a user tag identity response.

The “session beacon”: beacon can carry authenticated sessionID, e.g., sessionID.sequence@MAC, where MAC=base64 (HMAC(K, sessionID|sequence)). The beacon signal may be the plain session ID based “identity” as described above. Alternatively, the session ID based identity may be carried as identity in an EAP identity response message. This way, the beacon signal, when no association, broadcasts an EAP identity response message with the user tag actual identifier (ID), e.g. user@ user terminal emulation application, which can trigger the authentication to the user terminal emulation application via the I/O user device domain as described above. However, when there is an association and session available, the EAP identity response instead can carry the session ID based identity. The term K can be a shared secret known to the user tag and EAP Authenticator/IODH, e.g. PMK or key derived from PMK. Sequence is a wrapping sequence number, e.g. 32 bits long, where K could be re-generated when sequence wraps, and the sequence number is incremented for each broadcast.

The user tag transmits 1300 a user tag reference sequence (“Ref Seq” and “RS”) which corresponds to a beacon signal in accordance with various embodiments. IOD A receives and measures the beacon signal in operation “IOD UT-RS measurement”, and reports 1312 the beacon signal measurement in operation “IOD UT-RS measurement report” to the EAP authenticator. The EAP authenticator authenticates the beacon, e.g., based on the “third key” discussed above, and, when properly authenticated, relays 1314 the beacon and the accompanied beacon signal measurement to the IODH. The EAP authenticator may authenticate (verify) the beacon signal measurement based on, e.g., security set up and used between the EAP Authenticator and the IOD A. The beacon signal measurement may correspond to PwrRefSeqUT for a user tag “reference sequence” or “session beacon”, where “session beacon”: session related information, and where the beacon signal also carries an authenticated sessionID. Handling or the user tag beacon signal measurement procedures can include executing IOD user tag-RS measurement reporting, including PwrRefSeqUT for a UT “reference sequence” or “session beacon”. The EAP authenticator may authenticate the report of beacon signal measurement based on, e.g., infrastructure security such as long-lived security configuration in the I/O user device domain. Moreover, the EAP authenticator may authenticate or verify the beacon itself, such as based on the MAC as described above.

Similarly, the user tag continues to repetitively (e.g., periodically or nonperiodically) transmit 1320 the user tag “Ref Seq” which corresponds to a beacon signal in accordance with various embodiments. Alternatively, each of the I/O user devices (IOD A, IOD B, and IOD C) may receive the same beacon signal, so that the operations described below with regard to FIG. 13A for IOD B are performed in parallel with those of IOD A and IOD C. IOD B receives and measures the beacon signal in operation “IOD UT-RS measurement”, and reports 1322 the beacon signal measurement in operation “IOD UT-RS measurement report” to the EAP authenticator. The EAP authenticator authenticates the beacon signal measurement and optionally authenticates the beacon signal, and, when properly authenticated, relays 1324 the beacon signal measurement to the mobility manager. Alternatively, the mobility manager or the IODH may authenticate the beacon signal. The beacon signal measurement may correspond to PwrRefSeqUT for a user tag “reference sequence” or “session beacon”, where “session beacon”: session related information, and where the beacon signal also carries an authenticated sessionID. Handling or the user tag beacon signal measurement procedures can include executing IOD user tag-RS measurement reporting, including PwrRefSeqUT for a UT “reference sequence” or “session beacon”.

Similarly, the user tag continues to repetitively (e.g., periodically or nonperiodically) transmit 1330 the user tag “Ref Seq” which corresponds to a beacon signal in accordance with various embodiments. Alternatively, as explained above, each of the I/O user devices (IOD A, IOD B, and IOD C) may receive the same beacon signal. IOD C receives and measures the beacon signal in operation “IOD UT-RS measurement”, and reports 1332 the beacon signal measurement in operation “IOD UT-RS measurement report” to the EAP authenticator. The EAP authenticator authenticates the beacon signal measurement and optionally authenticates the beacon signal, and, when properly authenticated, relays 1334 the beacon signal measurement to the IODH. The IODH receives the IOD UT-RS beacon signal measurement report, which may contain PwrRefSeqUT for a UT “reference sequence” or “session beacon”, and where “session beacon” can be session related information such as sessionID.

When the session status is active, the IODH can determine the new/next I/O user device (target I/O user device) and set 1340 the TargetIODset to a member of the target UI capability (i.e., IOD A, IOD B, and/or IOD C). The IODH can send a message I/O user device stream ADD to a selected one or more of the I/O user devices (e.g., IOD A, IOD B, and/or IOD C) where a stream is being switched to, and where the ADD message may include user terminal emulation application details: FQDN, K_IOD_<this_IOD>, stream ID. The message sent directly or indirectly to the I/O user device(s) being added may include information identifying the old/source I/O user device to enable use of distributed communication stream routing schemes. The IODH can also send a message I/O user device stream REMOVE to one or more present I/O user devices which were being used to receive or generate a stream for the active session, and which triggers the one or more present I/O user devices to stop receiving or sending the stream and be removed from the session.

The user terminal emulation application can be provided with the IOD stream move information, such as the source I/O user device, the target I/O user device, and associated authentication and I/O user device stream configuration for the new or next I/O user device.

For active user sessions, the mobility management evaluations 1350 can be executed within a set of (e.g., directed toward) I/O user devices with currently in-use capabilities (also called TargetIODset). The operations can determine SourceIOD UI capabilities, and determine the TargetIODset based on matching the function of SourceIOD capability and TargetIOD capabilities for potential TargetIOD provided IOD UT-RS measurement report, and selecting the TargetIODset out of IOD@(capability==SourceIOD capability). For evaluation of user tag IOD to IOD mobility (UT IOD_IOD), the operations can consider ReceivePowerEvaluation (PwrRefSeqUT@sourceIOD, PwrRefSeqUT{ii}@IOD_TargetIODset{ii}). The term PwrRefSeqUT{ii}@IOD_TargetIODset{i} corresponds to IOD UT-RS beacon signal measurement reports. The beacon signal measurement report values can be filtered, as will be described in further detail below. The mobility evaluation can be performed based on ReceivePowerEvaluation (PwrRefSeqUT@sourceIOD, PwrRefSeqUT{ii}@IOD_TargetIODset{ii}) corresponds to respective enter/exit criterions.

The UT I/O user device to I/O user device mobility event can be triggered when: M_UT_IOD_target+Offset_target_IOD−Hyst>M_UT_IOD_source+Offset_source_IOD+Offset.

The UT I/O user device to I/O user device mobility event can be cancelled when: M_UT_IOD_target+Offset_target_IOD+Hyst<M_UT_IOD_source+Offset_source IOD+Offset.

The target I/O user device for the user tag can be selected 1350 and 1352 according to obtained TargetIOD out of TargetIODset. A message can be generated 1354 for “IOD stream ADD” and for the determined (selected) next I/O user device (TargetIOD) and, optionally, a corresponding other message for “IOD stream REMOVE” can be generated for the determined (selected) previous I/O user device (SourceIOD). The IOD data stream routing and termination operations can include sending the I/O user device stream ADD message directly or indirectly to the next I/O user device (e.g., IOD B) and the IOD stream REMOVE message can be sent to the previous (old) I/O user device (e.g., IOD A). The user terminal emulation application/EAP server can operate to remove 1360 the I/O user device stream for the sourceIOD A.

In FIGS. 13B and 14, the IODH operates to ADD the target I/O user device, e.g., via the step to generate 1354 and 1400 the message for “IOD stream ADD” for the determined (selected) next I/O user device (TargetIOD). Alternatively, the operations for adding the target I/O user device (e.g., IOD B) may include the IODH notifying the EAP authenticator to add the target I/O user device to an identified stream. The EAP authenticator can provide the add information to the target I/O user device. For example, in the example context of FIG. 5, the EAP authenticator 400 can receive the notification message from the IODH (FIG. 13A) corresponding to step 514A in FIG. 5 and operate to send an I/O user device stream ADD message to the target I/O user device (e.g., IOD B). The mobility manage may still send the I/O user device stream REMOVE message to the previous old I/O user device (e.g., IOD A).

Although FIGS. 13A and 13B are primarily directed to the active session scenario, when the session status is idle the IODH can set 1340 the TargetIODset to “any.” For IDLE user sessions, I/O user device mobility evaluations may be executed similarly, but within the set of any I/O user device detected in via IOD UT-RS measurement report and approved validity of by EAP Authenticator. Thus, operations for UI capability matching for the service are not necessary. In operation 1400, the IODH can add the target I/O user device to the set (Target IOD ADD) and can remove the source I/O user device from the set (Source IOD REMOVE).

Operations by the EAP authenticator can include to derive the key to be used for protecting identity carried in the user tag beacon signal, e.g., key used in HMAC. This could be based on PMK. EAP Authenticator can be utilized in 2 different ways, depending on how the beacon is carried.

According to the first way, if the beacon signal just carries the plain session ID based identity, the EAP authenticator is not involved in mobility events, other than for generating user tag specific keys. However, the EAP Authenticator derives the key to be used for beacon HMAC and provides it to IODH so that IODH can verify the beacon signals.

According to the second way, if the beacon signal carries the session ID and other data as identifier in an EAP Identity response message, I/O user devices can either forward the beacon/identity response to the EAP Authenticator or to the IODH. If forwarded to the IODH, the EAP authenticator does not play any further role than in the case when the beacon signal is just the plain session ID based identity. Thus, the rest of the description for EAP Authenticator is for the scenario where beacon carries and EAP Identity response message, which is by the IODs forwarded to the EAP Authenticator.

The EAP authenticator communicates with the IODH, and provides the verified beacon (e.g., verifies MAC etc. of session ID based identifier carried by EAP message), together with I/O user device reported signal strength, to the IODH so that the IODH can use the information to make mobility management decisions etc. When the beacon signal is just a plain session ID based beacon, the EAP authenticator generates I/O user device specific keys upon request from IODH and provides the key and other relevant info to the target I/O user device (directly or via IODH).

The EAP authenticator can optionally forward communication between the IODH and the user terminal emulation server.

The IODH receives beacon reports from I/O user devices, including beacon and signal strength etc. The EAP authenticator sends I/O user device specific key, user terminal emulation application FQDN, session ID and information about which stream the (target) I/O user device should request from the user terminal emulation application, e.g., which identifies stream currently being sent to the source I/O user device. This may be sent directly by the EAP authenticator or via the IODH.

The EAP authenticator verifies the received beacon identifier authenticity by verifying MAC, derives keys for I/O user devices based on PMK and I/O user device identifier (as provided by IODH), and updates user tag beacon signal protection key when sequence number wraps based on a KDF known to the user tag (UT) and EAP Authenticator.

The user terminal emulation application/EAP server, communicates directly or indirectly (e.g., via the EAP authenticator) with the IODH to optionally receive IOD stream move information (e.g., source I/O user device, target I/O user device). The user terminal emulation application/EAP server also communicates with the I/O user devices. The target I/O user device authenticates to user terminal emulation server and indicates the stream currently being sent to source I/O user device that should be moved to target I/O user device. The user terminal emulation server may verify this with information optionally received from the IODH. The user terminal emulation application/EAP server performs re-routing of the stream from the source I/O user device to the target I/O user device.

Some further embodiments are directed to operations for performing I/O user device to I/O user device mobility evaluation based on user tag beacon signal strength measurements.

An I/O user device or the IODH may apply filtering to the beacon signal strength measurement data before the data is used to evaluate if any mobility-triggering events has occurred at the usertag-layer (e.g., has a handover or other mobility rule been satisfied).

Filtering may be based legacy 3GPP L3 filtering procedures, the filtering is performed by either the I/O user device or the IODH instead of by a e/gNB according to 3GPP L3 filtering procedures.

In some embodiments, the filtering function is based on the following equation:

$$Fn = ( 1 - a ) * Fn - 1 + ( a * MEASn ) ,$$

where Fn=updated filtered measurement result,
Fn−1=previous filtered measurement result,
a=(½)^{k/4}, with k as filter coefficient, selected by IODH, and
MEASn=latest measurement result received from UT via source/target I/O user devices.

The latest measurement result, MEASn, may be based on {M_UT_IOD_target, M_UT_IOD_source}.

Depending on architectural choice, it can be advantageous for filtering to be performed by the IODH.

In some applications with capable I/O user devices and where filtering is based on parameters obtained from the IODH, I/O user devices may adopt the filtering and, e.g., make use of relaxed/hysteresis-based less frequent I/O user device measurement reporting to the IODH.

A user tag I/O user device to I/O user device mobility event can be configured to be triggered when an I/O user device beacon signal measurement report (from a first I/O user device) becomes better than another I/O user device beacon signal measurement report (from a second I/O user device) by a predefined offset value during a preset period of time (Time to Trigger, TTT). The offset value may either positive or negative, and offset values and TTT may be defined per individual I/O user device. In some embodiments, the user tag I/O user device to I/O user device mobility event is triggered when:

M_UT_IOD_target+Offset_target_IOD-Hyst>M_UT_IOD_source+Offset source IOD+Offset.

In some embodiments, the user tag I/O user device to I/O user device mobility event is cancelled when a user tag received beacon signal power detected at one (neighboring) I/O user device becomes worse than the user tag received beacon signal power detected at the current (source) I/O user device by an (I/O user device-specific is desired) offset during “time to trigger”. In some embodiments, the UT I/O user device to I/O user device mobility event is cancelled when:

M_UT_IOD_target+Offset_target_IOD+Hyst<M_UT_IOD source+Offset_source_IOD+Offset,
where:
M UT IOD_source: signal level or quality or UT received from source IOD to managing server;
M_UT_IOD_target: signal level or quality or UT received from target IOD to managing server;
Offset: UT IOD-IOD mobility is performed only when the signal of the UT at target IOD is significantly better than that of the UT received at the serving (source) IOD;
Offset_target_IOD: IOD-specific individual offset for the target IOD;
Offset_source_IOD: IOD-specific cell offset for the source IOD;
Time to Trigger: this timer helps to avoid irregular measurement and handover; and
Hyst: hysteresis, it is defined in managing node to avoid “ping-pong” with respect to mobility between two IODs.

Other embodiments are now explained which are directed to performing load balancing for radio cells which serve I/O user devices used for user terminal emulation as a cloud computing service through a user terminal emulation server.

Some of these embodiments can operate an overloaded radio cell of a network node based on 3GPP countermeasures or actions while further protecting user terminal emulation application communication services, and in a further aspect allow for parts of a communication service to be transferred to another lower-loaded radio cell of the same radio network node or another radio network node without introducing service interruption. The network node may be radio network node (e.g., e/gNB) or another, e.g., higher-level node, that helps control a radio network node.

Although some embodiments are described in the context of using 3GPP technology, these and other embodiments are also applicable to a combination of WiFi and 3GPP capable I/O user devices and network nodes.

In some embodiments, a home subscriber server (HSS) or unified data management (UDM) database can have device subscriptions which include an indication that the subscription is for an I/O user device and a pointer to the IODH which is responsible for managing or owning the I/O user device.

During operation a radio network node detects an overload condition of a served radio cell based on cellular measures (e.g., air interface, etc.). The radio network node requests a core network to further request an IODH to evaluate potential movement of communication streams (e.g., data, media, etc.) which are being sent and/or received by a served set of I/O user devices via a user terminal emulation server, in order to reduce the overload condition of the served radio cell. The movement operations can include finding a target set of I/O user devices which are served by a target radio cell that is not overloaded in order to move (re-route) one or more of the communication streams. The operation to identify I/O user devices for the target set may include to consider whether moving one of more of the communication streams would result in the target radio cell becoming overloaded (e.g., satisfy a defined overload condition) and, if so, further consider whether the communication stream bit rate can be reduced (e.g., lower resolution video) and kept with the serving cell or moved to a different target cell. The one or more of the communication streams may then be moved from the source set of I/O user devices served by the overloaded served radio cell to the target set of I/O user devices served by the non-overloaded target radio cell. The target radio cell may be provided by the same radio network node as the served radio cell or may be provided by another radio network node. The core network can access the HSS or UDM database to identify the subset of the served set of I/O user devices based on the subset being handled by a same I/O user device handler 212. When I/O user devices are identified, the IODH can operate to move the communication streams and trigger operations to notify the end-user that a communication stream will be moved to the target (alternative) I/O user device(s). The user may be notified through visual indication(s), audio indications, tactile indications, etc.

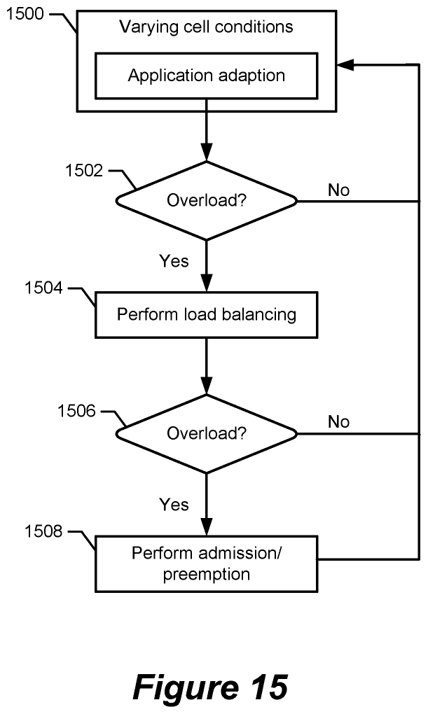

FIG. 15 illustrates a flowchart of operations that can be performed by a radio network node and core network to perform load balancing. Referring to FIG. 15, the operations are referred to as a “normal procedure” since load balancing is performed in a scenario when user terminal emulation is not being performed through I/O user communicating with a user terminal emulation server. Varying serving cell load conditions result from radio terminal applications have time-varying communication bit rates and other resource loading on the serving radio cell. The serving radio cell can become overloaded (overloaded condition), which triggers responsive load balancing operations that can involve movement of one or more radio terminals to a target radio cell which may be served by the radio network node or another radio network node. If the overloaded condition continues, then the radio network node and core network can perform admission controls or preemption which results in termination of service to user terminal(s) and/or ceasing admission of new user terminal(s) to the serving radio cell.

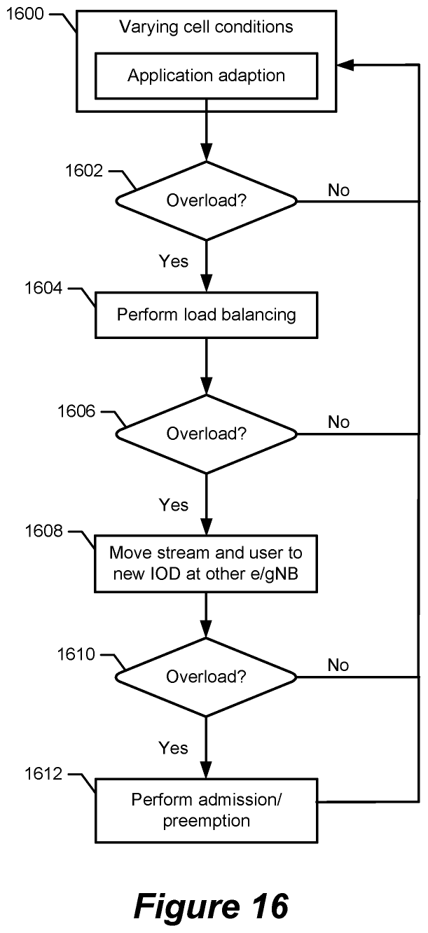

These operations are now contrasted with the operations of FIG. 16. FIG. 16 illustrates another flowchart of operations that can be performed by a radio network node, core network, and IODH to perform load balancing when user terminal emulation is being performed through I/O user communicating with a user terminal emulation server, in accordance with some embodiments of the present disclosure.

Referring to FIG. 16, the operations are referred to as an “extended procedure” since load balancing is performed in a scenario when user terminal emulation is being performed through I/O user communicating with a user terminal emulation server. Varying serving cell load conditions result from radio terminal applications have time-varying communication bit rates and other resource loading on the serving radio cell. The serving radio cell can become overloaded (overloaded condition), which triggers responsive load balancing operations that can involve movement of one or more radio terminals to a target radio cell which may be served by the radio network node or another radio network node. If the overloaded condition continues, then the radio network node, core network, and IODH can identify a target set of I/O user devices having I/O user interface capabilities which are capable of and available to handle media type characteristics of communication streams sent by and/or received by a subset of a served set of I/O user devices via the serving radio cell, and initiate movement of one or more of the communication stream(s) to the corresponding capable and available target I/O user device(s). If the overloaded condition still continues, then the radio network node and core network can perform admission controls or preemption which results in termination of service to user terminal(s) and/or ceasing admission of new user terminal(s) to the serving radio cell.

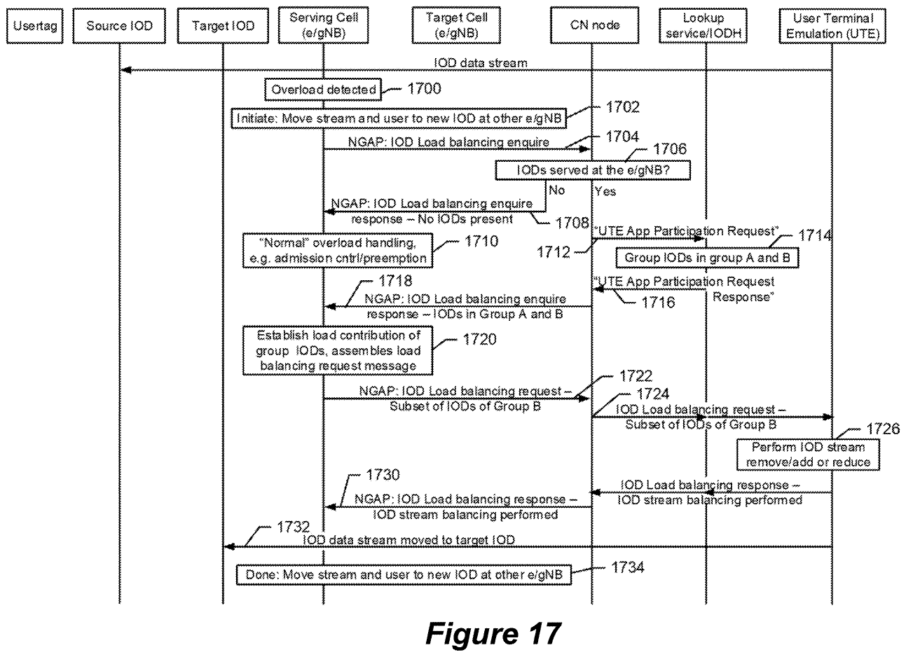

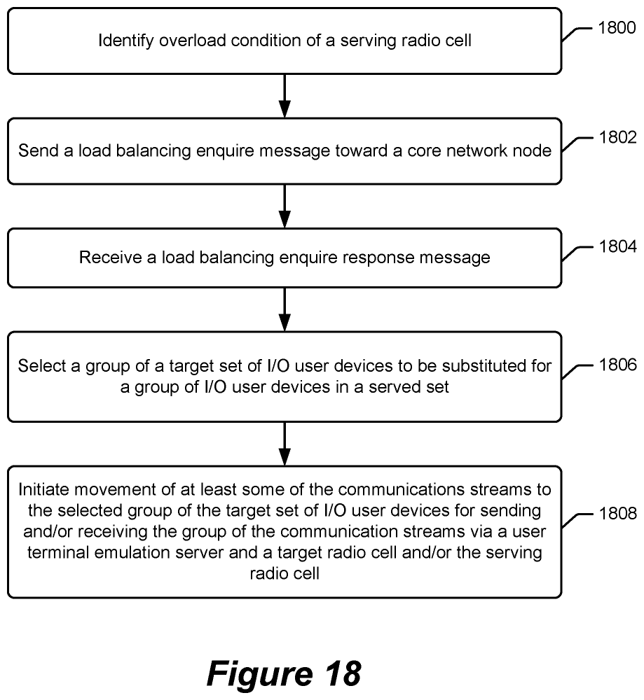

Operations that may be performed by a radio network node, a core network node, and an IODH are initially described in a broad sense with regard to FIGS. 18-20, and which are performed in accordance with some embodiments of the present disclosure. These and further operations are then described in the more detailed but non-limiting scenario of FIG. 17. While more broadly describing the operations of FIGS. 18-20 below, brief references are also made to more particular example illustrations of those operations in FIG. 17 and which are subsequently explained in further detail.

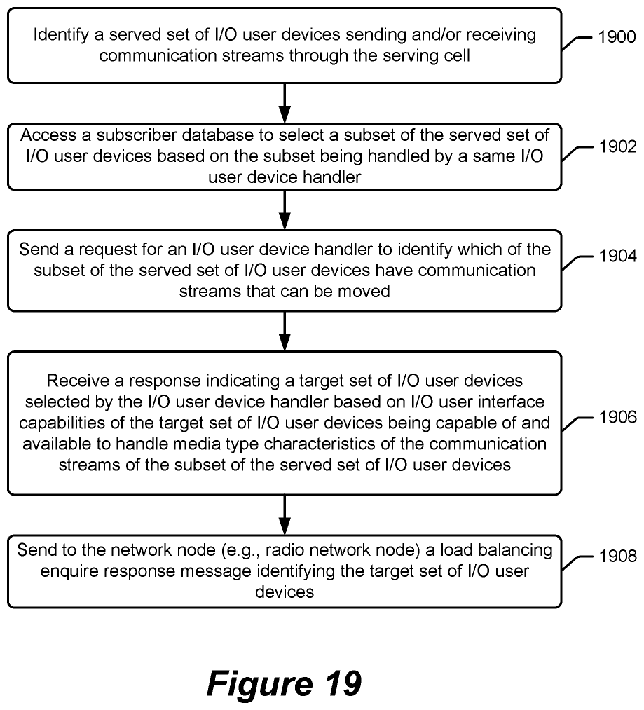

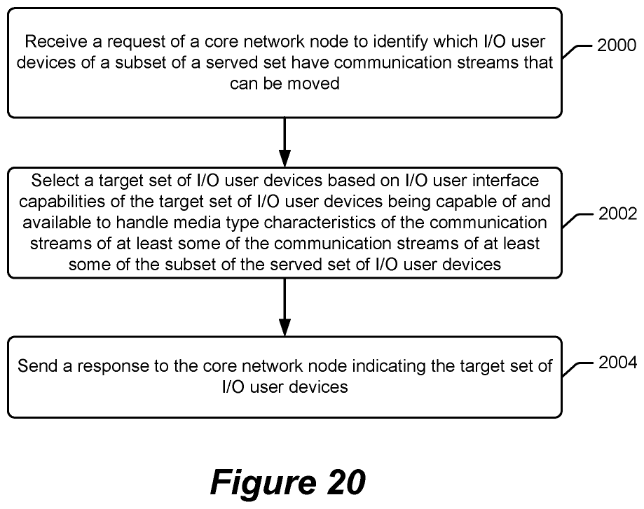

FIG. 17 illustrates combined flowcharts and data flows of a radio network node 1100 providing a serving cell, a core network (CN) node 1000, an IODH 212, and a user terminal emulation server 100 to perform load balancing when user terminal emulation is being performing through I/O user devices 130 (“source IOD” and “target IOD”) communicating with the user terminal emulation server 100. FIG. 18 illustrates a flowchart of operations that can be performed by the network node, e.g., radio network node 1100, for load balancing when user terminal emulation is being performing through I/O user devices 130 communicating with the user terminal emulation server. FIG. 19 illustrates a flowchart of operations that can be performed by the core network node 1000 for load balancing when user terminal emulation is being performed through I/O user devices 130 communicating with the user terminal emulation server 100. FIG. 20 illustrates a flowchart of operations that can be performed by the IODH 212 for load balancing when user terminal emulation is being performed through the I/O user devices 130 communicating with the user terminal emulation server 100.

Radio network node operations are now broadly described.

Referring to FIG. 18, the network node responds to an indication 1800 (e.g., 1700 in FIG. 17) of overload condition of a serving radio cell by performing operations that include to send 1802 (e.g., 1704 in FIG. 17) a load balancing enquire message toward a core network node 1000 to initiate a request for the IODH 212 to identify a target set of I/O user devices 130 having I/O user interface capabilities which are capable of and available to handle media type characteristics of communication streams sent by and/or received by a subset of a served set of I/O user devices via the serving radio cell and a user terminal emulation server 100. The operations receive 1804 (e.g., 1718 in FIG. 17) a load balancing enquire response message identifying the target set of I/O user devices, and select 1806 (e.g., 1720 in FIG. 17) a group of the target set of I/O user devices to be substituted for a group of the I/O user devices in the served set. The operations initiate 1808 (e.g., 1722 in FIG. 17) movement of at least some of the communications streams to the selected group of the target set of I/O user devices for sending and/or receiving the group of the communication streams via the user terminal emulation server 100 and a target radio cell and/or the serving radio cell. The operation to initiate movement may include to the send to the IODH 212 a request to perform defined I/O user device add and remove commands.

In one example scenario, a subset of the served set has 10 different types of I/O user devices and a target set has 10 I/O user devices of same type. In this scenario, a maximum of one of the communication streams may be identified (for selection 1806/1720) as being able to be moved from the served set to the target set. However, in some further embodiments, additional information is associated with the target set that identifies what type of streams the target set and/or served set of I/O user devices can handle, and may provide a clear mapping between substitutable I/O user devices, such as served I/O user device A can be replaced with target I/O user device X or Y etc. Such additional information may be provided by the IODH 212. Providing this additional information for the sets enables more effective selection of streams to modified (e.g., moved) and estimation of the effort of applying modifications.

The load balancing enquire message may include user tag received signal measurements which have been reported by I/O user devices 130 served by the serving radio cell, so that the IODH 212 may use the signal measurements when identifying which of the candidate subset of the served set of I/O user devices can have their communication streams moved. Thus, in one embodiment, the network node 1100 can generate the load balancing enquire message to include user tag received signal measurements that have been reported by I/O user devices served by the serving radio cell. Alternatively, the I/O user devices may report the user tag received signal measurements more directly to the IODH 212.

The load balancing enquire message may include indications of quality of service (QoS) and/or service level agreement (SLA) defined for the communication streams served by the serving radio cell, so that the IODH 212 can determine which I/O user devices 130 to include in the target set it identifies back to the radio network node 1100. Thus, in one embodiment, the operation to send 1802 the load balancing enquire message toward the core network node 100, can include to generate the load balancing enquire message to include indications of QoS and/or SLA defined for the communication streams served by the serving radio cell.

The load balancing enquire message may include indications of which of the communication streams served by the serving radio cell are preferred to be moved or not moved, so that the IODH 212 can determine which I/O user devices 130 to include in the target set it identifies back to the network node 1100. Thus, in one embodiment, the operation to send 1802 the load balancing enquire message toward the core network node 100, can include to generate the load balancing enquire message to include indications of which of the communication streams served by the serving radio cell are preferred to be moved or not moved.

The load balancing enquire message may include indications of I/O user devices 130 served by the serving radio cell that are preferred to be moved or not moved, so that the I/O user device handler can determine which I/O user devices to include in the target set it identifies back to the network node. Thus, in one embodiment, the operation to send 1802 the load balancing enquire message toward the core network node 100, can include to generate the load balancing enquire message to include indications of which of the I/O user devices served by the serving radio cell are preferred to be moved or not moved.

The operation to initiate 1808 movement of at least some of the communications streams to the selected group of the target set of I/O user devices 130, can include to send a load balancing request identifying the selected group of the target set of I/O user devices 130 that are to add the at least some of the communications streams, e.g., by operation of the user terminal emulation server 100.

Core network node operations are now broadly described.

Referring now to FIG. 19, the core network node 1000 operates in a corresponding manner to respond to receipt (e.g., 1704 in FIG. 17) of a load balance enquire message of a serving radio cell by performing operations that include to identify 1900 (e.g., 1706 in FIG. 17) a served set I/O user devices sending and/or receiving communication streams through the serving cell and the user terminal emulation server 100. The core network node 1000 accesses 1902 (e.g., 1706 in FIG. 17) a subscriber database (e.g., 211 in FIGS. 2 and 3) to select a subset of the served set of I/O user devices based on the subset being handled by a same I/O user device handler (212). The core network node 1000 sends 1904 (e.g., 1712 in FIG. 17) a request for the IODH 212 to identify which of the subset of the served set of I/O user devices have communication streams that can be moved. The core network node 1000 receives 1906 (e.g., 1716 in FIG. 17) a response indicating a target set of I/O user devices selected by the IODH 212 based on I/O user interface capabilities of the target set of I/O user devices being capable of and available to handle media type characteristics of the communication streams of at least some of the subset of the served set of I/O user devices. The core network node 1000 sends 1908 (e.g., 1718 in FIG. 17) to the network node 1100 a load balancing enquire response message identifying the target set of I/O user devices.

The core network node 1000 may check the subscriptions of its served I/O user devices to identify which are registered with the same I/O user device handler (212), and responsively request the IODH 212 to identify which are available for use for moving the associated communication streams. The operation to access 1902 (e.g., 1706 in FIG. 17) the subscriber database to select the subset of the served set of I/O user devices based on the subset being handled by the same I/O user device handler (212), may include to identify from the subscriber information an address of the I/O user device handler 212 responsible for managing communication services by the selected I/O user devices. The request is then sent 1904 (e.g., 1712 in FIG. 17) using the address of the IODH 212.

The core network node 1000 may cause the IODH 212 to evaluate movement of a communication stream to an I/O user device served by the serving radio cell that is already subject to an overload condition, but where the communication stream would have a lower bit rate if moved and thereby reduce loading of the serving radio cell. In one embodiment, the core network node 1000 causes the IODH 212 to prioritize selection of an I/O user device for the target set that is served by the serving radio cell and has a better radio link quality (e.g., improved signal strength (RSRP) and/or signal to noise (and interference) SINR, channel quality indicator (CQI), etc.) and/or is capable of handling a media type characteristic of one of the communication streams at a lower bit rate than the one of the communication streams. The evaluation decision may be based on bit rate or more generally based on other aspects of quality of service, which may include delay, packet loss, etc.

The load balancing enquire message (1704 in FIG. 17) may include user tag received signal measurements which have been reported by I/O user devices served by the serving radio cell, so that the IODH 212 may use the signal measurements when identifying which of the subset of the served set of I/O user devices can have their communication streams moved. In one embodiment, the core network node 1000 further operates to obtain from the load balance enquire message, user tag received signal measurements that have been reported by I/O user devices served by the serving radio cell. The core network node 1000 then generates the request to include user tag received signal measurements, for sending to the IODH 212 to identify which of the subset of the served set of of I/O user devices are available to use for moving the communication streams.

The request sent 1904 (e.g., 1712 in FIG. 17) by the core network node 1000 to the IODH 212 can include indications of the QoS and/or SLA defined for the communication streams served by the serving radio cell, so that the IODH can determine which I/O user devices to include in the target set it identifies back to the radio network node 1100. In one embodiment, the core network node 1000 operates to obtain QoS and/or SLA which is defined for the communication streams served by the serving radio cell, and generates the request to include indications of the QoS and/or SLA defined for the communication streams served by the serving radio cell.

The request sent 1904 (e.g., 1712 in FIG. 17) to the IODH 212 can include indications of which of the communication streams served by the serving radio cell are preferred to be moved or not moved, so that the IODH 212 can determine which I/O user devices to include in the target set it identifies back to the radio network node 1100. In one embodiment, the core network node 1000 operates to obtain indications of which of the communication streams served by the serving radio cell are preferred to be moved or not moved, and generates 1904 (e.g., 1712, in FIG. 17) the request to include the indications of which of the communication streams served by the serving radio cell are preferred to be moved or not moved.

To offload I/O user devices for load balancing, the core network node 1000 may operate to receive (e.g., 1722 in FIG. 17) a load balancing request identifying a selected group of the target set of I/O user devices that are to add at least some of the communications streams by operation of the user terminal emulation server 100. The core network node 1000 can responsively send (e.g., 1724 in FIG. 17) the load balancing request to the I/O user device handler (212) to initiate movement by addition of the at least some of the communications streams to the selected group of the target set of I/O user devices.

Some further embodiments are directed to the core network node 1000 providing radio network nodes 1100 with estimates of radio cell resource loading if a communication stream is moved to a capable and available one of the I/O user devices in the target set. In one embodiment, for each of at least a plurality of the communication streams, the core network node 1000 operates to determine based on content of the received (e.g., 1716 in FIG. 17) response an estimate of radio cell resource loading if the communication stream is moved to a capable and available one of the I/O user devices in the target set of I/O user devices. One example embodiment operates to exchange information between the IODH and core network node, e.g., necessary performance metrics (e.g., historical relation tables) or other correlation-based estimation processes, used to determine resource loading. Alternatively or additionally, further messaging may occur between the IODH and the core network node to operationally estimate radio cell resource loading if the communication stream is moved to a capable and available one of the I/O user devices in the target set of I/O user devices. The core network node 1000 may further determine whether a radio cell loading rule is satisfied by the estimate of radio cell resource loading if the communication stream is moved to the capable and available one of the I/O user devices in the target set of I/O user devices. When the radio cell loading rule is satisfied, the core network node 1000 may send a stream movement authorization message to the IODH 212 indicating that the communication stream is to be moved to the capable and available one of the I/O user devices in the target set of I/O user devices.

IODH operations are now broadly described.

Referring now to FIG. 20, the IODH 212 operates to receive 2000 (e.g., 1712 in FIG. 17) a request of the core network node 1000 to identify which I/O user devices 130 of the subset of a served set, which are served by a serving radio cell, have communication streams that can be moved. The IODH 212 selects 2002 (e.g., 1714 in FIG. 17) a target set of I/O user devices based on I/O user interface capabilities of the I/O user devices being capable of and available to handle media type characteristics of the communication streams of at least some of the subset of the served set of I/O user devices, and sends 2004 (e.g., 1716 in FIG. 17) a response to the core network node 1000 indicating the target set of I/O user devices. The response may further indicate which I/O user devices of the target set can be used to take over for which I/O user devices of the served set, and data profiles of the I/O user devices, the communication, streams, etc.

The IODH 212 may further select the target set of I/O user devices based on user tag received signal measurements which have been reported by I/O user devices served by the serving radio cell. In one embodiment, any I/O user device which receives a beacon of a user tag can be a candidate to take over a communication stream of that user tag regardless of whether served by a specific radio cell.

In one embodiment, the IODH 212 may use the signal measurements when identifying which of the subset of the served set of I/O user devices can have their communication streams moved.

The IODH 212 may identify which of the subset of the served set of I/O user devices can have their communication streams moved based on indications of QoS and/or SLA defined for the communication streams served by the serving radio cell. In one embodiment, the IODH 212 obtains from the request, indications of QoS and/or SLA defined for the communication streams served by the serving radio cell. The IODH 212 then further selects 2002 (e.g., 1714 in FIG. 17) which of the subset of the served set of I/O user devices can have their communication streams moved based on the indications of QoS and/or SLA defined for the communication streams.

The IODH 212 may further identify which of the subset of the served set of I/O user devices can have their communication streams moved based on indications of communication streams served by the serving cell which are preferred to be moved or not moved. In one embodiment, the IODH 212 obtains from the request, indications of communication streams preferred to be moved or not moved. The IODH 212 then further selects 2002 (e.g., 1714 in FIG. 17) which of the subset of the served set of I/O user devices can have their communication streams moved based on the indications of communication streams preferred to be moved or not moved.

The IODH 212 may identify which of the subset of the served set of I/O user devices can have their communication streams moved based on indications of I/O user devices that are preferred to be moved or not moved. In one embodiment, the IODH 212 obtains from the request, indications of I/O user devices that are preferred to be moved or not moved. The IODH 212 then further selects 2002 (e.g., 1714 in FIG. 17) which of the subset of the served set of I/O user devices can have their communication streams moved based on the indications of I/O user devices preferred to be moved or not moved.

Some further embodiments are directed to providing radio network nodes with estimates of radio cell resource loading if a communication stream is moved to a capable and available one of the I/O user devices in the target set. In one embodiment, for each of at least one of the communication streams, the IODH 212 determines an estimate of radio cell resource loading if the communication stream is moved to the capable and available one of the I/O user devices in the target set. The IODH 212 then generates the response (2004) to include the estimates of resource loading.

The IODH 212 may receive a stream movement authorization message from the core network node 1000 indicating a defined communication stream is to be moved to a defined capable and available one of the I/O user devices in the target set of I/O user devices. The IODH 212 may responsively add the defined communication stream to the defined capable and available one of the I/O user devices in the target set of I/O user devices, and then remove the defined communication stream from another I/O user device which had been handling the defined communication stream.

Reference is now made to FIG. 17 to discuss operations of the illustrated system according to a more particular non-limiting scenario. Combined flowcharts and data flows are illustrated for the radio network node 1100 providing a serving cell, the core network node 1000, the IODH 212, and the user terminal emulation server 100 to perform load balancing when user terminal emulation is being performing through I/O user devices 130 (“source IOD” and “target IOD”) communicating with the user terminal emulation server 100.

As explained above, the subscriber database (e.g., HSS 211 in FIGS. 2 and 3, and UDM) can store I/O user device subscriptions with an indication that the subscription is for an I/O user device useable for user terminal emulation service and provide a pointer to the IODH which manages or owns the I/O user device. The pointer to the IODH could also act as an implicit indication that this subscription is for an I/O user device useable for user terminal emulation service. Based on this information the core network can programmatically group all I/O user devices belonging to the same IODH.

The knowledge that the subscription is for an I/O user device could be known a combination of the core network and to the radio network node (e.g., e/gNB) serving the I/O user device. The knowledge could be based on signaling, e.g., communicated to radio network node (e.g., e/gNB) as part of session key provisioning, or e.g. based on knowing that the radio network node (e.g., e/gNB) is only serving I/O user device useable for user terminal emulation service (e.g. private network, non-private network, or dedicated radio cell via closed access group).

During operation a radio network node (e.g., e/gNB) detects 1700 (FIG. 17) an overload condition for a serving radio cell considering cellular measures (air interface, etc.). Responsive to the overload condition, the radio network node (e.g., e/gNB) performs operations 1702 to move communication streams and corresponding users (UEs or I/O user devices) to another radio cell which may be served by another radio network node or the same radio network node. If the radio network node (e.g., e/gNB) is aware of the user terminal emulation type of service (e.g., according to one or more embodiments disclosed herein) the radio network node (e.g., e/gNB) sends one or more requests 1704 (e.g., “IOD load balancing enquire”) towards the core network (CN) node or mobility management entity (MME) node to request, e.g., via over-the-top, for the IODH (also called a “lookup service/IODH”) to indicate a target set of I/O user devices (130) having I/O user interface capabilities which are capable of and available to handle media type characteristics of communication streams of at least some of the served I/O user devices, and their potential status. The status may indicate a preference with respect to mobility, such as an indication that “IODH does not want a particular I/O user device to be moved from a current serving radio cell and/or serving radio network node” versus another indication that “IODH allows performing mobility actions on the UE or I/O user device”. The status may alternatively or additionally indicate session information such as QoS or “real-time communication” (e.g., video stream), “best effort communication” (e.g., file download), associated bandwidth requirements, etc. If the radio network node (e.g., e/gNB) is not aware of the user terminal emulation type of service, it can just indicate to the core network that it has an overloaded condition.

If the core network node determines that no I/O user devices are providing user terminal emulation service through the serving radio cell of the radio network node, it can send 1708 an I/O user device load balancing enquire response message indicating the outcome of the determination. The radio network node (e.g., e/gNB) can respond to such response message by performing “normal” overloaded handling 1710, e.g., admission control and/or preemption.

The request message from the core network to the IODH can be referred to as a “user terminal emulation (UTE) application participation request”.

When I/O user devices are determined to be providing user terminal emulation service through the serving radio cell, the core network node can determine from entries in the HSS or UDM the identities of IODHs that have I/O user devices being served by the radio network node (e.g., e/gNB) experiencing overload. For example, the core network node can check the subscriptions of all UEs being served by the radio network node (e.g., e/gNB) for an indication that it is an I/O user device subscription usable for user terminal emulation. When the core network finds such subscriptions, it identifies from the subscription information the pointer to the managing IODH. The core network node or a mobility management entity node sends 1712 a “user terminal emulation (UTE) application participation request” message to the identified IODH(s) indicating which subscriptions or I/O user devices that the core network node wants to disengage, e.g., the I/O user device subscriptions being served by the overloaded radio network node (e.g., e/gNB).

In a further aspect, the request may apart from “participation” also request to obtain indications for I/O user devices' respective type of associated communication stream (e.g., audio, video, upload, download, a combination of types, etc.), QoS contract, service-paired UEs or I/O user devices, and/or which are active or idle communication state.

The IODH can operate to try to find I/O user devices (target set of I/O user devices) to take over (add) communication streams of other I/O user devices (subset of the served set of I/O user devices).

The IODH obtains from the request a list of the I/O user devices (the subset of the served set) being served by the overloaded serving radio cell of the radio network node (e.g., e/gNB). The IODH may first need to translate between “UE ID” (e.g., the ID use by the core network to identify UEs or other types of I/O user devices) to “an I/O user device ID” (e.g., how IODH identifies UEs or I/O user devices). The IODH may determine alternative I/O user devices based on the I/O user devices' respective UT-RS measurement reporting, e.g., I/O user devices that could replace I/O user device(s) which are active for a UT.

The IODH identifies 1714 if there is a possibility to move some communication stream(s) from an I/O user device being served by the overloaded serving radio cell of the radio network node (e.g., e/gNB) to an I/O user device served by another radio cell of the same or another radio network node considering, for example: 1) associated service, QoS, and/or SLA; and/or 2) idle, active in a session associated by the current user or active in a session associated with a different user (which may be determined implicitly from IODset information). It is noted that the IODH might not know if the target I/O user device would be served by same or different radio cell as it might not know which radio cell is serving a specific I/O user device. However, the IODH may provide to the core network node alternatives of where streams of currently used I/O user devices can be moved (i.e., mapping identified I/O user devices to which other I/O user devices), and the core network node and/or e/gNB (radio network node) can then evaluate which of the given options might make a positive impact on the overload situation.

The IODH may determine which I/O user devices can be suitable for load balancing actions as well as which I/O user devices should not be moved in order to maintain an ongoing communication service. It is noted that the IODH may proactively make I/O user device mobility decisions and move communication streams between I/O user devices.

The IODH sends 1716, e.g., a “user terminal emulation application participation request response” message carrying one or more of: 1) a list of I/O user devices that can be used for load balancing, e.g., I/O user devices that the IODH has determined are acceptable for being moved as part of RAN mobility and/or load balancing, as well as their respective candidate at another e/gNB for scenarios where IODH helps with load balancing via IOD stream mobility and also the traffic profile for the IOD/stream; and 2) an indication of I/O user devices that the IODH prefers not to be moved and/or modified (e.g., to a lower bit rate) from their current role. It is noted that the IODH might not know at which e/gNB (radio network node) an I/O user device is served, and may therefore indicate which I/O user device streams can be taken over by target IODs. The core network node and/or e/gNB (radio network node) can then make a choice, e.g., based on the operator network knowing where I/O user devices are served.

The response 1716 thus indicates which I/O user devices are allowed to be disengaged and the corresponding target I/O user devices or UEs and associated traffic profiles, etc., of the I/O user devices (e.g., what type of traffic is to be expected from the communication streams handled by the I/O user devices). This information may be used by the core network node to determine a more optimized load at multiple radio network nodes (e.g., e/gNBs). The response can also provide IODH-based priority indication for various of the I/O user devices, which can assist the core network and/or the radio network node (e.g., gNB) with performing load balancing in a manner that minimizes the effect of the users of the I/O user devices, e.g. load-balancing while avoiding movement of communication stream from an I/O user device that the IODH indicates should not be moved or is identified as a lower priority for moving.

The core network node may, based on the received information, further filter and narrow down the target set to potential mobility operations that can help to remedy the overload condition. These operations can be useful if there are multiple overloaded radio network nodes (e.g., e/gNBs) and the core network node can attempt to perform an overall optimization compared to the local optimization that one radio network node (e.g., e/gNB) can alone perform. Then, either the filtered or full target set is optionally provided 1718 to the requesting radio network node (e.g., e/gNB) in, e.g., a “user terminal emulation application participation request response” message.

The requesting radio network node (e.g., e/gNB), or the core network node if the requesting radio network node is not involved in the process, can determine based on information entities in the received message, two forms of served I/O user devices, characterized as two groups by:
1. Group A: “I/O user devices (UE) listed as part of an ongoing IODH session” and tagged as “blocked for radio network node (e/gNB) load balancing actions”, e.g., IODH has indicated that these I/O user devices should ideally not be moved
2. Group B: “I/O user devices (UE) listed as part of ongoing IODH session” and available for load balancing actions

The overloaded radio network node (e.g., e/gNB) and/or the core network node then calculates the possible reduction in load by scenarios for moving communication streams (even complete disengage) belonging to Group B. The overloaded radio network node operations 1720 can include selecting a group (set) of the target set of I/O user devices in Group B, where individuals of the group may be more resource-demanding than, e.g. an average I/O user device, such as due to sending and/or receiving a high bit rate video stream. The operations assemble (generate) 1722 an “IODH load balancing request message” for “any I/O user devices in the select group” which can convey: a set of resource consuming streams hosted by the overloaded radio network node (e.g., e/gNB) per I/O user device; which target I/O user devices can take over communication streams from the served I/O user devices (e.g., based on information earlier received from the IODH 212; and a metric indicating how much resources the overloaded radio network node (e.g., e/gNB) requests to have offloaded (e.g., one, two, . . . or other identified number of media I/O user devices, a bit rate reduction metric, etc.), which can be referred to as “cellular offload metric.”

The overloaded radio network node (e.g., e/gNB) 1722 sends and/or the core network node sends 1724 an “IODH load balancing request message” towards the IODH via the core network node or MME. The IODH can use the message 1722 to perform 1726 re-route of the communication stream(s).

The IODH receives the “IODH Load Balancing Request Message” 1724 from the core network node or the MME, and implicitly from the overloaded radio network node (e.g., e/gNB), and converts “cellular information” to “User Terminal Emulation Application” information, e.g. UE ID converted to I/O user device ID and “Cellular offload metric” converted to “I/O user device load metric”.

The IODH selects and assesses 1726 at least one usertag (UT with involved I/O user device(s), e.g., via lookup of I/O user device UT-RS measurement report, containing “reference sequence” or “session beacon” or sessionID, and where UT for some of its I/O user devices has some application data bitrate>threshold.

For all selected and assessed UT, the IODH applies 1726 UT mobility measurement evaluation, e.g., as described above for SourceIOD-to-TargetIOD for “capability-continuity”, and identifies possible target I/O user device for UT mobility. This operation can be deduced based on request from the core network node, which indicates which I/O user devices are being served by the overloaded radio network node. The operations can thereby identify candidates for:
I/O user device stream ADD; and
I/O user device stream REMOVE.

The user terminal emulation server performs 1726 I/O user device stream ADD and I/O user device stream REMOVE for some or all UT ii based on the assessment of the reduction of the I/O user device load metric. These operation may include moving a stream from a 3GPP technology access to/from a WiFi technology access.

The IODH sends 1730 an “IODH load balancing request message response” to the core network node or MME (implicitly to a certain radio network node). The response informs that load balancing is performed with an indication of how much offload that has been done and possibly to which radio network node. It is noted that the IODH 212 might not know about radio network nodes, and may therefore indicate from which I/O user device a communication stream is to be moved to what I/O user device.

As shown in FIG. 17, a communication stream is moved 1732 to the target I/O user device which enables the user to access 1734 the ongoing communication service provided through the user terminal emulation server using the UI capabilities of the target I/O user device.

The radio network node is continuously monitoring the load situation and may repeat the load balancing request again. It may also take further actions as admission control/pre-emption according to state of art procedures.

The core network node or MME may optionally when receiving the “IODH Load Balancing Request Message Response”, operate to: evaluate future radio network node (e.g., e/gNB) load as suggested I/O user device mobility, as indicated by response from IODH, is applied; and assemble another “IODH Load Balancing Request Message”, if needed. Alternatively, the core network node or MME may send an acknowledgement (ACK) or send an additional request to the IODH 212 to modify the executed changes. The other IODH Load Balancing Request Message may include a subset of I/O user device mobility actions that the core network node wants the IODH to apply, e.g., actions that help the load situation in the overloaded radio network node(s). This is relevant when the core network node tries to optimize load at multiple radio network nodes simultaneously and multiple IODHs suggest or apply I/O user device communication stream mobility operations that might otherwise in combination result in a less-than-optimal situation.

The core network node or MME sends 1730 the IODH load balancing request message response towards the IODH. The IODH and/or the user terminal emulation server receives the IODH load balancing request message from the core network node or the MME, and may repeat operations of FIG. 17 including for reception of another “IODH Load Balancing Request Message”.

Some further embodiments are directed to operations prior to executing an action to move a communication stream to a target I/O user device, whereby the IODH and/or the user terminal emulation server provides the overloaded radio network node (e/gNB), the MME, and/or the core network node with associated intent information, which enables the nodes (e.g., MME, core network node, radio network node, etc.) to forecast the future load situation for the “targeted I/O user device” at the corresponding serving radio cell provided by the corresponding radio network node if the candidate move is performed with an identified communication stream.

Various of the above described operations can be modified to enable the forecasted impact of a candidate move as explained above.

The IODH, without performing I/O user device or stream mobility operations, determines which I/O user device(s) are identified as candidates for: stream ADD (e.g., now a new I/O user device for UT having needed capability while served by non-loaded I/O user device (e.g., being a I/O user device at some not overloaded radio network node (e/gNB)); and stream REMOVE (i.e. removing stream towards old I/O user device (e.g., being the previous I/O user device at the requesting overloaded radio network node (e/gNB)). The IODH assembles (generates) an “IODH Load Balancing Request Message Response” which can include: 1) identity of I/O user device subject to release of stream (at requesting e/gNB); 2) identity of I/O user device subject to addition of stream (at unknown e/gNB); and 3) estimate of associated DeltaLoadMetric (DLM) corresponding to each “steam ADD” for considered communication service provided through the user terminal emulation server. The IODH sends the “IODH load balancing request message response” towards the radio network node (e/gNB) via the core network node or the MME.

Operations by the core network node or the MME can include to receive the “IODH Load Balancing Request Message Response” including: 1) identity of I/O user device subject to REMOVE of stream (at requesting radio network node (e/gNB)); and 2) identity of I/O user device subject to ADD of stream. The operations identify the target radio cell of the radio network node (e/gNB) for the I/O user device subject to ADD of stream. The operations can further include to compare based on IODH or managing node obtained estimated service load metric (e.g. bitrate, DeltaLoadMetric (DLM)) associated with a possible future I/O user device stream ADD/REMOVE action for concerned I/O user devices, e.g. according to:
IF load (e/gNB for “to be REMOVED”)>=load (e/gNB for “to be ADDED”), OR.
IF load (e/gNB for “to be REMOVED”)>=load (e/gNB for “to be ADDED”)+DLM, OR.
IF load (e/gNB for “to be REMOVED”)-DLM>IF load (e/gNB for “to be ADDED”)+DLM.

IF LoadEvaluation (“e/gNB subject to REMOVE”//“e/gNB for “to be ADDED”)==OK. The operations by the core network node or MME send towards IODH and/or the user terminal emulation server a “MME/CN IOD stream ADD LoadEvaluation Message”==OK.

The IODH and/or the user terminal emulation server receives from the core network node or MME the “MME/CN ADD OK message”, and execute stream ADD, and stream REMOVE.

Optionally, the operations send a “MME/CN ADD OK Response Message” towards the core network node, where the message can include:
IOD stream ADD==OK/NOK.
IOD stream REMOVE==OK/NOK.

The core network node, MME, or radio network node (e/gNB) may operate to receives “IOD stream ADD OK Response Message”, and operate to initiate movement to release the removed I/O user device(s) (UE(s)) into a pool of “eMBB IODs”. The cellular system may target the released I/O user device(s) (“IOD removed”) at the radio network node (e/gNB) with other load balancing actions.

### Abbreviations

3GPP 3^{rd} Generation Partnership Project’
App Application, i.e. program
AKMA Authentication and Key Management for Applications
BS Base station, e.g., e/gNB
BT Bluetooth
CAG Closed Access Group
CN Core network
DL Downlink
DLM Delta Load Metric
EAP Extensible Authentication Protocol
e/gNB Evolved Node B, Next Generation Node B
eMBB Enhanced Mobile Broadband
eNB Evolved Node B (a.k.a. RBS, Radio Base Station)
FQDN Fully Qualified Domain Name
GW Gateway (also. acronym for Leif GW Persson)
HSS Home Subscriber Server
HO Handover
ICMP Internet Control Message Protocol
IOD Input and/or Output Device
IODH IOD Handler
ITU International Telecommunication Union
KDP Key Derivation Function
MIMO Multiple Input Multiple Output
MME
Mobility Management Entity
NFC Near Field Communication
NPN Non-Public Networks
RFID Radio Frequency Identification
RSRP Reference Symbol Received Power
RTP Real Time Protocol
RTCP Real Time Control Protocol
IOD Input Output Device
IODH Input Output Device Handler
NTP Network Time Protocol
S1 Interface in 3GPP LTE
SDP Session Description Protocol
SR Sender Response
SRS Sounding Reference Symbol (or Signal)
TTT Time To Trigger
UDM Unified Data Management
UE User equipment
UL Uplink
UT User Tag
X2/Xn Interface in 3GPP between eNBs or gNBs

### Further Definitions and Embodiments

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the appended examples of embodiments are intended to cover all such modifications, enhancements, and other embodiments, which fall within the spirit and scope of present inventive concepts. Thus, to the maximum extent allowed by law, the scope of present inventive concepts is to be determined by the broadest permissible interpretation of the present disclosure including the following examples of embodiments and their equivalents, and shall not be restricted or limited by the foregoing detailed description.

1. A network node comprising:
at least one processor; and
at least one memory storing program code that is executable by the at least one processor to respond to an indication of overload condition of a serving radio cell by performing operations comprising to:
send a load balancing enquire message toward a core network node to initiate a request for an input and/or output, I/O, user device handler to identify a target set of I/O user devices having I/O user interface capabilities which are capable of and available to handle media type characteristics of communication streams sent by and/or received by a subset of a served set of I/O user devices via the serving radio cell and a user terminal emulation server;
receive a load balancing enquire response message identifying the target set of I/O user devices;
select a group of the target set of I/O user devices to be substituted for a group of the I/O user devices in the served set; and
initiate movement of at least some of the communications streams to the selected group of the target set of I/O user devices for sending and/or receiving the group of the communication streams via the user terminal emulation server and a target radio cell and/or the serving radio cell.

2. The radio network node of claim 1, wherein the operation to send the load balancing enquire message toward the core network node to initiate the request for the I/O user device handler to identify the target set of I/O user devices, comprises to:
generate the load balancing enquire message to include user tag received signal measurements that have been reported by I/O user devices served by the serving radio cell.

3. The network node of claim 1, wherein the operation to send the load balancing enquire message toward the core network node to initiate the request for the I/O user device handler to identify the target set of I/O user devices, comprises to:
generate the load balancing enquire message to include indications of quality of service, QoS, and/or service level agreement, SLA, defined for the communication streams served by the serving radio cell.

4. The network node of claim 1, wherein the operation to send the load balancing enquire message toward the core network node to initiate the request for the I/O user device handler to identify the target set of I/O user devices, comprises to:
generate the load balancing enquire message to include indications of which of the communication streams served by the serving radio cell are preferred to be moved or not moved.

5. The network node of claim 1, wherein the operation to send the load balancing enquire message toward the core network node to initiate the request for the I/O user device handler to identify the target set of I/O user devices, comprises to:
generate the load balancing enquire message to include indications of which of the I/O user devices served by the serving radio cell are preferred to be moved or not moved.

6. The network node of claim 1, wherein the operation to initiate movement of at least some of the communications streams to the selected group of the target set of I/O user devices for sending and/or receiving the group of the communication streams via the user terminal emulation server and the target radio cell and/or the serving radio cell, comprises to:
send toward the core network node a load balancing request identifying the selected group of the target set of I/O user devices that are to add the at least some of the communications streams.

7. A core network node comprising:
at least one processor; and
at least one memory storing program code that is executable by the at least one processor to perform operations comprising to respond to receipt of a load balance enquire message of a serving radio cell by performing operations comprising to:
identify a served set of input and/or output, I/O, user devices sending and/or receiving communication streams through the serving cell;
access a subscriber database to select a subset of the served set of I/O user devices based on the subset being handled by a same I/O user device handler;
send a request for the I/O user device handler to identify which of the subset of the served set of I/O user devices have communication streams that can be moved;
receive a response indicating a target set of I/O user devices selected by the I/O user device handler based on I/O user interface capabilities of the target set of I/O user devices being capable of and available to handle media type characteristics of the communication streams of at least some of the subset of the served set of I/O user devices; and
send to a network node a load balancing enquire response message identifying the target set of I/O user devices.

8. The core network node of claim 7, wherein the operation to access the subscriber database to select the subset of the served set of I/O user devices based on the subset being handled by the same I/O user device handler, comprises to:
select I/O user devices for including in the subset based on subscriber information indicating the I/O user devices are registered with the I/O user device handler.

9. The core network node of claim 8, wherein the operation to access the subscriber database to select the subset of the served set of I/O user devices based on the subset being handled by the same I/O user device handler, further comprises to:
identify from the subscriber information an address of the I/O user device handler responsible for managing communication services by the selected I/O user devices,
wherein the request is sent using the address of the I/O user device handler.

10. The core network node of claim 7, wherein the operation to access the subscriber database to select the subset of the served set of I/O user devices based on the subset being handled by the same I/O user device handler, comprises to:
prioritize selection of I/O user devices for the subset that are served by the target radio cell.

11. The core network node of claim 7, wherein the operation to access the subscriber database to select the subset of the served set of I/O user devices based on the subset being handled by the same I/O user device handler, comprises to:
prioritize selection of an I/O user device for the subset that is served by the serving radio cell and have a better radio link and/or are capable of handling a media type characteristic of one of the communication streams at a lower bit rate than the one of the communication streams.

12. The core network node of claim 7, wherein the operations further comprise to:
obtain from the load balance enquire message, user tag received signal measurements that have been reported by I/O user devices served by the serving radio cell; and
generate the request to include user tag received signal measurements, for sending to the I/O user device handler to identify which of the subset of the served set of I/O user devices can have their communication streams moved.

13. The core network node of claim 7, wherein the operations further comprise to:
obtain quality of service, QoS, and/or service level agreement, SLA, defined for the communication streams served by the serving radio cell; and
generate the request to include indications of the QoS and/or SLA defined for the communication streams served by the serving radio cell.

14. The core network node of claim 7, wherein the operations further comprise to:
obtain indications of which of the communication streams served by the serving radio cell are preferred to be moved or not moved; and
generate the request to include the indications of which of the communication streams served by the serving radio cell are preferred to be moved or not moved.

15. The core network node of claim 7, wherein the operations further comprise to:
obtain indications of which of the I/O user devices served by the serving radio cell are preferred to be moved or not moved; and
generate the request to include the indications of which of the I/O user devices served by the serving radio cell are preferred to be moved or not moved.

16. The core network node of claim 7, wherein the operations further comprise to:
receive a load balancing request identifying a selected group of the target set of I/O user devices that are to add at least some of the communications streams by operation of a user terminal emulation server; and
send the load balancing request to the I/O user device handler to initiate movement by addition of the at least some of the communications streams to the selected group of the target set of I/O user devices.

17. The core network node of claim 7, wherein the operations further comprise to:
for each of at least a plurality of the communication streams, determine based on content of the received response an estimate of radio cell resource loading if the communication stream is moved to a capable and available one of the I/O user devices in the target set of I/O user devices.

18. The core network node of claim 17, wherein the operations further comprise to:
determine whether a radio cell loading rule is satisfied by the estimate of radio cell resource loading if the communication stream is moved to the capable and available one of the I/O user devices in the target set of I/O user devices; and
when the radio cell loading rule is satisfied, send a stream movement authorization message to the I/O user device handler indicating that the communication stream is to be moved to the capable and available one of the I/O user devices in the target set of I/O user devices.

19. An input and/or output, I/O, user device handler comprising:
at least one processor; and
at least one memory storing program code that is executable by the at least one processor to perform operations comprising to:
receive a request of a core network node to identify which input and/or output, I/O, user devices of a subset of a served set, which are served by a serving radio cell, have communication streams that can be moved;
select a target set of I/O user devices based on I/O user interface capabilities of the target set of I/O user devices being capable of and available to handle media type characteristics of the communication streams of at least some of the subset of the served set of I/O user devices; and
send a response to the core network node indicating the target set of I/O user devices.

20. The I/O user device handler of claim 19, wherein the operations further comprise to:
obtain from the request, user tag received signal measurements that have been reported by I/O user devices served by the serving radio cell; and
further select which of the subset of the served set of I/O user devices can have their communication streams moved based on the user tag received signal measurements.

21-28. (canceled)
